(19) United States
(12) Patent Application Publication
(10) Pub. No.: US 2025/0056637 A1
(43) Pub. Date: Feb. 13, 2025

(54) PACKET DATA CONVERGENCE PROTOCOL LAYER ENCODING/DECODING PROCEDURES FOR CELL-FREE NETWORKS

(71) Applicant: APPLE INC., Cupertino, CA (US)

(72) Inventors: Danila Zaev, Munich (DE); Ahmed M. Soliman, Munich (DE); Ahmed Gamal Helmy Mohamed, Cupertino, CA (US); Ayman F. Naguib, Cupertino, CA (US)

(21) Appl. No.: 18/798,519

(22) Filed: Aug. 8, 2024

Related U.S. Application Data
(60) Provisional application No. 63/518,655, filed on Aug. 10, 2023.

(51) Int. Cl. H04W 76/15; H03M 13/15; H04L 1/00; H04L 1/22; H04L 9/06

(52) U.S. Cl. CPC H04W 76/15; H03M 13/1515; H04L 1/0057; H04L 1/22; H04L 9/0618

(57) ABSTRACT

Packet data convergence protocol (PDCP) layer encoding and decoding procedures for use in cell-free networks are disclosed. A transmitter (e.g., a user equipment (UE) or a cluster of base stations that serves a UE) performs PDCP processing using a PDCP entity by: generating a concatenated service data unit (SDU) set by concatenating a plurality of SDUs for a protocol data unit (PDU) set; segmenting the concatenated SDU set into one or more systematic PDUs of the PDU set; performing an encoding with the one or more systematic PDUs to generate one or more redundant PDUs of the PDU set; and distributing the one or more systematic PDUs and the one or more redundant PDUs across one or more radio link control (RLC) entities for transmission. Complimentary processes performed by a PDCP entity of a receiver (e.g., a cluster of base stations or a UE) are also disclosed.

### TECHNICAL FIELD

This application relates generally to wireless communication systems, including enhancements to PDCP layer processing (e.g., PDCP layer encoding and decoding) in cell-free networks.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for one example of the use of PDU sets in a real-time application context.

FIG. 2 illustrates a diagram for an example of clustering in a cell-free network architecture.

FIG. 3 illustrates a diagram showing aspects of radio protocol use in cell-free network mechanisms.

FIG. 4 illustrates an example of a PDU set corresponding to a use of a Reed-Solomon erasure coding mechanism.

FIG. 5 illustrates a network topology and a corresponding protocol stack according to an embodiment.

FIG. 6A and FIG. 6B illustrate graphs of one dataset for the use of various PDCP PDU coding strategies and for various numbers of PDUs in the case of a stationary UE.

FIG. 7A and FIG. 7B illustrate graphs of one dataset for the use of various PDCP PDU coding strategies and for various numbers of PDUs in the case of a highly mobile UE.

FIG. 8A illustrates a flowchart for the functionality of a PDCP entity at a transmitter, according to embodiments discussed herein.

FIG. 8B illustrates a flowchart for a functionality of a PDCP entity at a receiver, according to embodiments discussed herein.

FIG. 9A and FIG. 9B taken together illustrate differences between first PDCP entity processing as used in prior PDCP entities and second PDCP entity processing as used by improved PDCP entities as contemplated herein.

FIG. 10 illustrates a diagram of PDCP processing at a PDCP entity as may be used by a transmitter, according to embodiments herein.

FIG. 11 illustrates a diagram of PDCP processing at a PDCP entity as may be used by a receiver, according to embodiments herein.

FIG. 12 illustrates a diagram of a protocol for PDU set encoding as may be used by a PDCP entity of a transmitter, according to embodiments herein.

FIG. 13 illustrates a diagram for the non-integrated handling of PDU sets using virtual PDU sets by a PDCP entity at a transmitter, according to embodiments herein.

FIG. 14 illustrates a method of a UE that is served by a cluster of base stations for PDCP processing for a PDCP entity, according to embodiments discussed herein.

FIG. 15 illustrates a method of a UE that is served by a cluster of base stations for PDCP processing for a PDCP entity, according to embodiments discussed herein.

FIG. 16 illustrates a method of a cluster of base stations that is serving a UE for PDCP processing for a PDCP entity, according to embodiments discussed herein.

FIG. 17 illustrates a method of a cluster of base stations that is serving a UE for PDCP processing for a PDCP entity, according to embodiments discussed herein.

FIG. 18 illustrates an example architecture of a wireless communication system, according to embodiments disclosed herein.

FIG. 19 illustrates a system for performing signaling between a wireless device and a network device as supported by a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### PDU Sets for Real-Time Applications

In the context of various wireless communication systems, a protocol data unit (PDU) set may be understood as a group of one or more PDUs that (e.g., together) make up the payload of one unit of information generated at an application level. For example, a PDU set may represent a unit of information that is a frame or video slice/tile. In various cases, such PDU sets are used in real-time service contexts, such as extended reality (XR) and/or media contexts.

In some wireless communication systems used to implement extended reality and/or media services contexts, it may be that in a media layer, packets in a PDU set are decoded/handled as a whole/holistically. For example, it may be that a frame/video slice may be successfully decoded in cases where all (or at least a sufficient amount) of the packets carrying the frame/video slice are successfully delivered to the receiver. As another example, a frame within a group of pictures (GOP) may be decoded by a client in a case where all frames on which that frame depends are successfully received.

In these and other contexts, a corresponding group of packets within a PDU set may be understood to have an inherent dependency to each other with respect to their use at the media layer. From a packet data convergence protocol (PDCP) layer point of view, an enhancement may be suggested for a PDCP discard operation in uplink. The enhancement may be provided as timer-based discard operation that, when applied, applies to/affects all service data units (SDUs)/PDUs of a same PDU set.

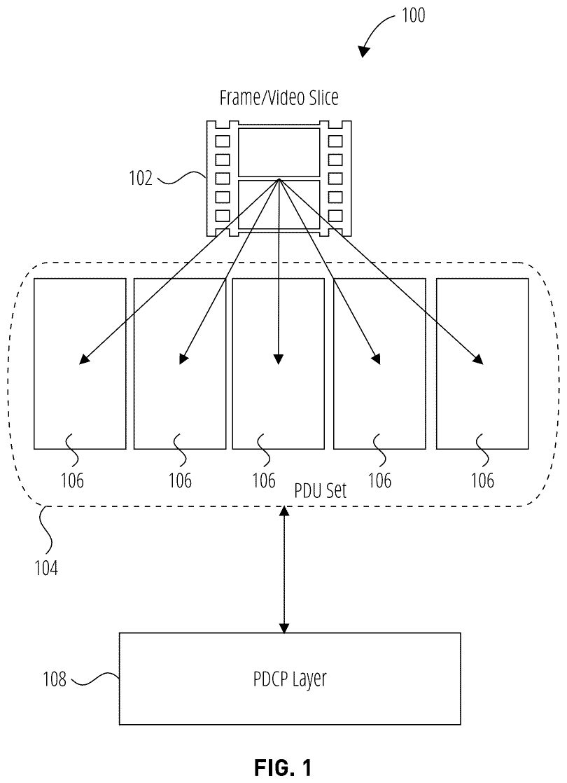

FIG. 1 illustrates a diagram 100 for one example of the use of PDU sets in a real-time application context. The real-time application may be, for example, a media application that transports data corresponding to the frame/video slice 102 over the network to a receiver. This transmission may occur in terms of a PDU set 104 that includes one or more PDUs 106 having (ultimately) the data packets making up the data of the frame/video slice 102. As illustrated, a PDCP layer 108 may be used to process the PDU set 104. It may be that the PDUs 106 (e.g., the data packets of the PDUs) have an inherent dependency between them (e.g., all or at least a sufficient number of the PDUs 106 is required to be successfully decoded at the receiver to successfully recreate the frame/video slice 102 at the receiver side). This characteristic may be the cause of the arrangement of the PDUs 106 into the same PDU set 104, as illustrated. As illustrated, a PDCP layer 108 at each of the transmitter and the receiver may perform operations corresponding to the PDU set 104.

A PDU set (e.g., PDUs, corresponding service data units (SDUs), and/or packets for a PDU set) may be associated with a PDU set integrated handling information (PSIHI) parameter. A PSIHI parameter may indicate whether all PDUs of within a PDU set are needed for proper/useful usage of the PDU set by the application layer in the receiver side.

Embodiments discussed herein relate to the handling of PDU sets at a PDCP layer in a manner that achieves advantages. These advantages may be useful in the case of, for example, real-time applications occurring in the context of cell-free communications. Some embodiments discussed herein correspond to procedures for PDU sets associated with a PSIHI parameter=TRUE. Some embodiments discussed herein relate to procedures for PDU sets associated with a PSIHI parameter=FALSE.

### Clustering in Cell-Free Networks

In some wireless communication systems, a cell-free network architecture provides an adaptive/dynamic and UE-centric distribution of functionalities that may be associated with a “serving cell” as understood in the context of prior cell-based network architectures (e.g., such as an NR network architecture or an LTE network architecture). With respect to the present disclosure, it may be understood generally that a “cluster” or “serving cluster” of a UE is a set of physically and/or logically connected base stations over which functionalities related to the serving the UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

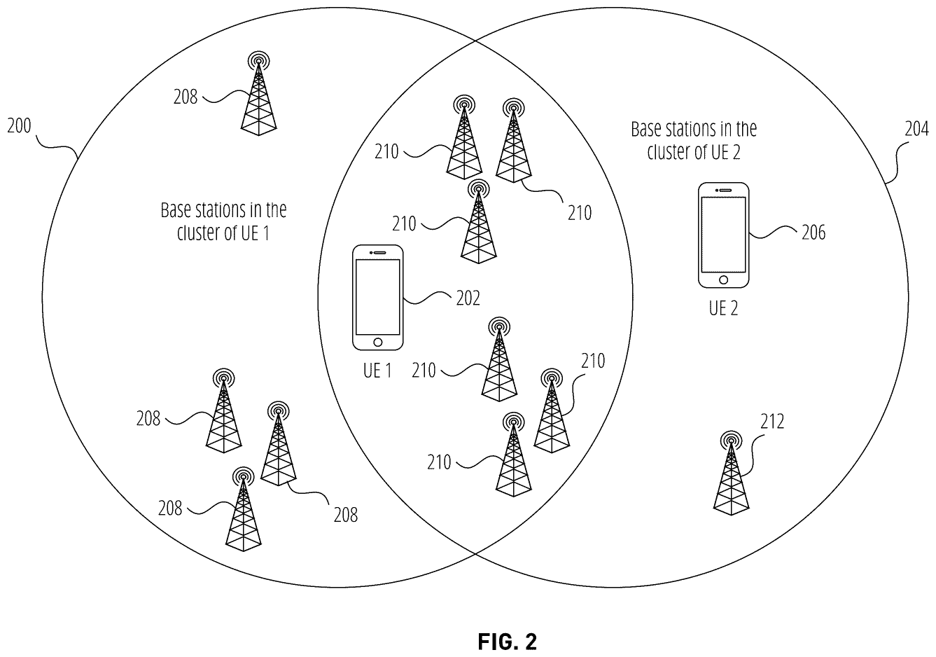

FIG. 2 illustrates a diagram for an example of clustering in a cell-free network architecture. A first cluster 200 of base stations serves a first UE 202 and a second cluster 204 of base stations serves the second UE 206. As illustrated, the first cluster 200 includes the first base stations 208 and the second base stations 210, while the second cluster 204 includes the second base stations 210 and the third base station 212.

Base stations in a same cluster are not necessarily required to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core network, a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QOS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE's initial access). These may include, for example, “greedy”, downlink (DL)-based, uplink (UL)-based, and/or real-time methodologies (and any corresponding message exchanges).

### Radio Protocols in Cell-Free Networks

In some wireless communication systems, “cluster partitioning” represents a radio-bearer-specific dynamic partition of a cluster serving a UE into logical sub-clusters. Such a cluster partitioning into sub-clusters may be determinative of a protocol stack architecture that applies with respect to that cluster. For example, sub-clusters according to the partitioning may be in one-to-one correspondence with RLC entities. Base stations in a same sub-cluster may then, for example, each carry a copy of the same logical RLC entity for a given radio bearer.

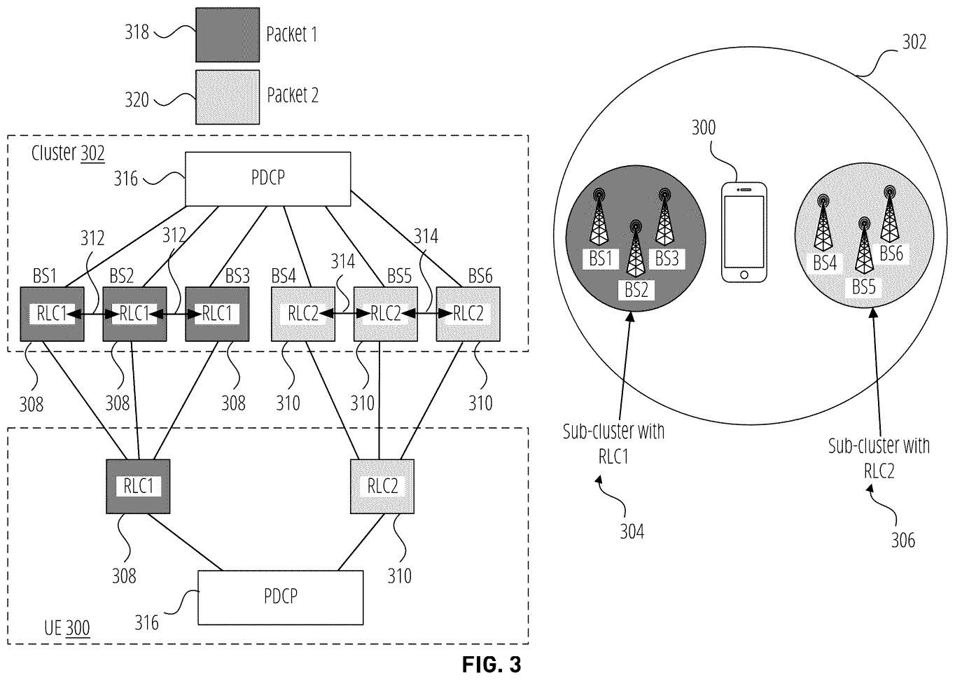

FIG. 3 illustrates a diagram showing aspects of radio protocol use in cell-free network mechanisms. A UE 300 is served by a cluster 302. Within the cluster 302, there is a first sub-cluster 304 that corresponds to a first RLC entity 308 used between the UE 300 and the cluster 302 and a second sub-cluster 306 that corresponds to a second RLC entity 310 between the UE 300 and the cluster 302. The first RLC entity 308 and the second RLC entity 310 are RLC entities used by a PDCP entity 316 that corresponds to a radio bearer between the UE 300 and the cluster 302 and that uses the illustrated cluster partitioning.

As illustrated, the first RLC entity 308 is synchronized 312 across the base stations of the first sub-cluster 304 (BS1, BS2, and BS3). This means that, for example, each of these base stations has and operates according to a copy of the first RLC entity 308, as shown. Further, the second RLC entity 310 is synchronized 314 across the base stations of the second sub-cluster 306 (BS4, BS5, and BS6). This means that, for example, each of these base stations has and operates according to a copy of the second RLC entity 310, as shown. Note that, as illustrated, the arrangement of particular base stations of the cluster into the first sub-cluster 304 or second sub-cluster 306 may be transparent to the UE (the UE knows about/operates in terms of the first RLC entity 308 and the second RLC entity 310 (in terms of the sub-clusters), without consideration with respect to particular base stations underlying those RLC entities/sub-clusters).

In the illustrated case, a first packet 318 of the radio bearer corresponding to the PDCP entity 316 is handled at the first RLC entity 308. This ultimately means that the first packet 318 is communicated between the UE 300 and the cluster 302 via one or more of the base stations of the first sub-cluster 304. Further, a second packet 320 of the (same) radio bearer corresponding to the PDCP entity 316 is handled at the second RLC entity 310. This ultimately means that the second packet 320 is communicated between the UE 300 and the cluster 302 via one or more of the base stations of the second sub-cluster 306.

It is contemplated that a cluster partitioning may be updated over time. Establishment and/or updating of a cluster partitioning may take into account QoS requirements and traffic properties associated with a radio bearer. For example, latency constraints, and/or traffic periodicity may be considered. These mechanisms allow the network (e.g., a CCF) to optimally configure sub-cluster-enabled multi-connectivity of a UE to a cluster in, for example, a non-ideal backhaul scenario (where different partitionings of a same cluster may have appreciably different QoS/traffic management characteristics).

In some wireless communication systems, radio protocols in cell-free networks utilize concepts such as cluster partitioning/sub-clusters, RLC synchronization, etc. A functionality for control over dynamically updating cluster partitions, and a corresponding protocol for the update procedure, may be used. PDCP data routing options and a corresponding configuration may be used. Finally, a cell-free radio bearer configuration and/or a message exchange procedure for radio bearer establishment may be used.

In various embodiments disclosed herein, details of PDCP layer design and PDCP-to-RLC routing logic are discussed.

### Embodiments for Reed-Solomon Erasure Coding for PDU Sets

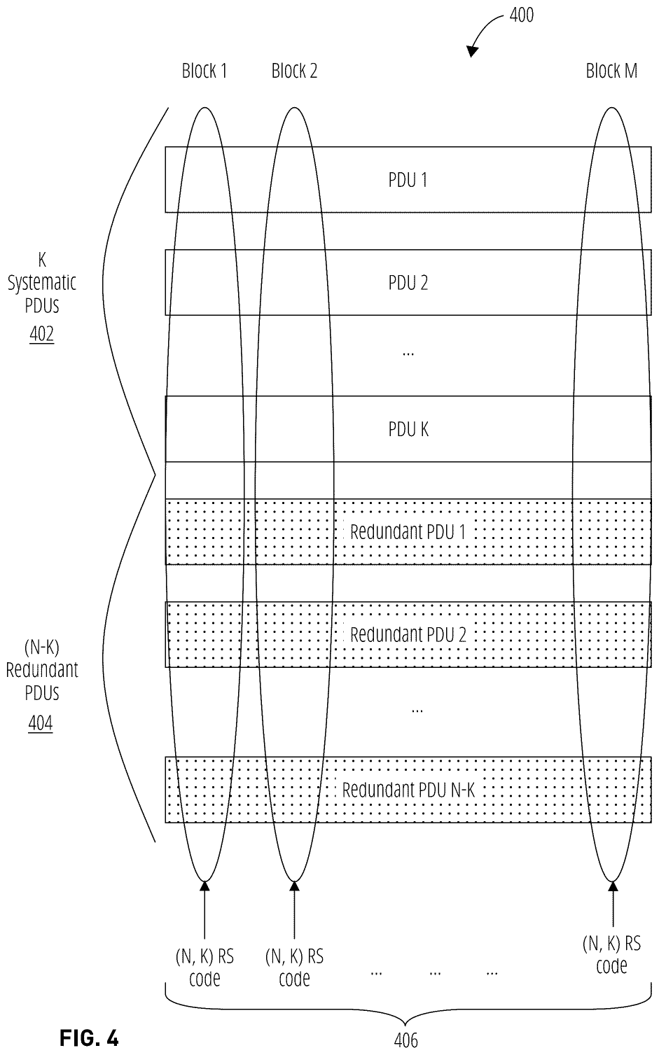

One example of an efficient mechanism for the use of erasure correcting code (erasure coding) over symbols is Reed-Solomon coding mechanism. FIG. 4 illustrates an example of a PDU set 400 corresponding to a use of a Reed-Solomon erasure coding mechanism. The PDU set 400 includes the K systematic PDUs 402 and the N-K redundant PDUs 404 (where N represents the total number of the systematic PDUs 402 and the redundant PDUs 404 in the PDU set 400).

Generation of the PDU set 400 using the Reed-Solomon mechanism is now explained. The systematic PDUs 402 together represent the original data as provided in SDUs, as spread among the systematic PDUs 402. Then, the systematic PDUs 402 may be coded 406 with systematic Reed-Solomon (N, K) erasure coding over GF(2⁴), where q is a symbol size in bits, applied “vertically” symbol-wise to K systematic PDUs to arrive a N encoded PDUs (as illustrated in FIG. 4 by the use of “(N, K) RS code” as shown). The use of this coding 406 over the systematic PDUs 402 results in the generation of the N-K redundant PDUs 404 on the symbol-wise basis.

This PDU set 400 (including both the systematic PDUs 402 and the redundant PDUs 404) is then sent by the transmitter.

At the receiver side, the use of the Reed-Solomon erasure coding mechanism as illustrated may enable the receiver to correct or fill up to N-K erasures from the PDU set 400 (where one “erasure” corresponds to a failed receipt of one PDU of the PDU set 400). This means that in cases of up to N-K erasures, the receiver may nevertheless ultimately recover K original PDUs having successfully received any number K PDUs out of N total encoded PDUs. This property may hold when the number K of successfully received PDUs were also transmitted without error by the transmitter, and/or when the decoder at the receiver has an accurate understanding of which PDUs are successfully received and which PDUs are erased.

Erasure codes under a Reed-Solomon scheme may be applied to in cases of PDUs having a same size (e.g., with each PDU being split into a same number M of blocks on the block-wise basis, as shown).

### Embodiments for PDU Set Processing in Cell-Free Networks

Embodiments herein relate to PDU set processing by PDCP entities in cell-free networks. Corresponding to such cases, it may be understood that a PDU set is processed by the PDCP entity in a particular manner that may be different from processing used at the PDCP entity for a single PDU (a PDU that is not part of a PDU set). Note that functionalities of a PDCP entity as described herein may be understood to be carried out at a PDCP layer for the underlying device.

A PDCP entity may be implemented by one of the nodes of the cluster (e.g., a base station) or be implemented in a cloud (server or edge) node. In the case of implementation in a base station, other cluster entities (e.g., other base stations) can connect to the PDCP entity using an Xn interface. In the case of a cloud-based implementation, the PDCP entity can be accessed through a dedicated interface between the cluster nodes (base stations) and the cloud entity (e.g., over an F1-U interface). In various embodiments, a PDCP entity could be part of RAN centralized unit (CU) or distributed unit (DU) functionality or part of a core network functionality (e.g., combined or implemented closely with a user plane function (UPF)).

In embodiments discussed herein, content for a PDU set (e.g., data of SDU(s)) may be merged and segmented into equally sized packets, with the result understood as representing one or more systematic PDUs. These are then encoded with an erasure code (for example, with using a systematic Reed-Solomon erasure coding mechanism) to generate redundant PDUs. The systematic PDUs and the redundant PDUs may be routed to available radio link control (RLC) entity(s) in a manner that takes advantage of any diversity provided by cluster partitioning mechanism used within a cell-free communication scheme.

In various embodiments, packet coding rates, segmentation schemes, and/or routing policies may be adaptively selected by the PDCP entity in the transmitter (and in cases where a UE is the transmitter, the network may assist the UE with these selection(s) for its PDCP entity).

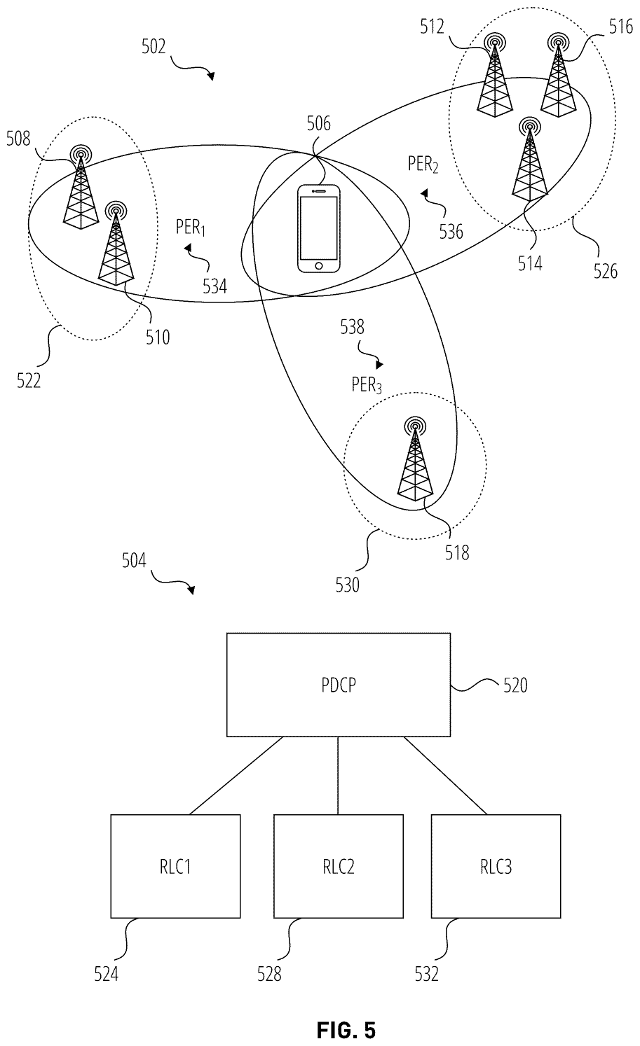

FIG. 5 illustrates a network topology 502 and a corresponding protocol stack 504 according to an embodiment. The network topology 502 illustrates a UE 506 that is served by a cluster of base stations that includes the first base station 508, the second base station 510, the third base station 512, the fourth base station 514, the fifth base station 516, and the sixth base station 518. The cluster communicates with the UE 506 using a radio bearer that corresponds to the PDCP entity 520 of the protocol stack 504.

Further, according to a cluster partitioning that has occurred for the bearer in the cluster: the first base station 508 and the second base station 510 make up a first sub-cluster 522 that corresponds to a first RLC entity 524 of the protocol stack 504; the third base station 512, the fourth base station 514, and the fifth base station 516 make up a second sub-cluster 526 that corresponds to a second RLC entity 528 of the protocol stack 504, and the sixth base station 518 makes up a third sub-cluster 530 that corresponds to a third RLC entity 532 of the protocol stack 504.

A PERₖ value may be understood to represent a PDU error rate of a k-th sub-cluster/RLC. Accordingly, as illustrated in FIG. 5, communications between the UE 506 and the first sub-cluster 522 using first RLC entity 524 may occur according to a first PDU error rate 534 (PER₁), communications between the UE 506 and the second sub-cluster 526 using the second RLC entity 528 may occur according to a second PDU error rate 536 (PER₂), and communications between the UE 506 and the third sub-cluster 530 using the third RLC entity 532 may occur according to a third PDU error rate 538 (PER₃).

In one example, the UE 506 runs a real-time application according to low-latency communication parameters (for example, a cloud-based XR application). As the UE 506 supports a connection with three sub-clusters as illustrated, it thus has 3 RLC buffers. The network may have non-ideal backhaul(s) between the sub-clusters, and therefore joint precoding operation is not feasible. Further, due to the applicable low-latency parameters, it may be that relatively few hybrid automatic repeat request (HARQ) retransmissions are available, thus a PDCP PDU error rate may be relatively high in some circumstances. Under this general understanding, the following two scenarios may be considered:

In a first scenario, the UE 506 may be considered stationary. In this case it may be that PER₁=PER₂=PER₃=1%. This case may correspond to the case of block error rate (BLER)=10% with one retransmission.

In a second scenario, the UE 506 may be highly mobile. In this case, it may be that PER₁=10%, PER₂=20%, PER₃=30%. This may represent an example of a case of relatively unreliable communication under low-latency constraints, with (for example) no retransmission possibilities.

Within these contexts, various strategies may be considered. In a first such strategy, communication with the UE 506 via a single RLC/sub-cluster (one of the first sub-cluster 522, the second sub-cluster 526, and the third sub-cluster 530). This strategy may provide the best reliability, with the lowest PDU error rate. In this case, data is not multiplexed, meaning that the data rate factor for this case is 1.0.

In a second such strategy, communication with the UE 506 occurs via all the RLCs/sub-clusters (through all of the first sub-cluster 522, the second sub-cluster 526, and the third sub-cluster 530), where packets are duplicated through all three RLCs/sub-clusters (three copies of each PDU are sent, one copy through each RLC/sub-cluster). The data rate factor for this case is ⅓.

In a third such strategy, communication with the UE 506 occurs via all the RLCs/sub-clusters (through all of the first sub-cluster 522, the second sub-cluster 526, and the third sub-cluster 530), and erasure packet coding is used, In such cases, various data rate factors (e.g., rate ⅔, rate ½, rate ⅓) are possible, depending on the configuration for the erasure packet coding process.

Cases corresponding to each of these strategies can be analyzed in terms of the success probability of a PDU set delivery as compared with the corresponding radio resource consumption. This relationship can then be compared as between each case.

For such analyses as presented herein, it may be that the success/failure of each PDU transmission is assumed to be independent of other transmissions. Further, it may be understood that the given modeling is most reasonable when PDUs are allocated in a small number of code block groups (CBGs) of a transport block, and where these may be delivered to the upper layers independently in the case of a successful physical (PHY) cyclic redundancy check (CRC) check of those corresponding CBGs.

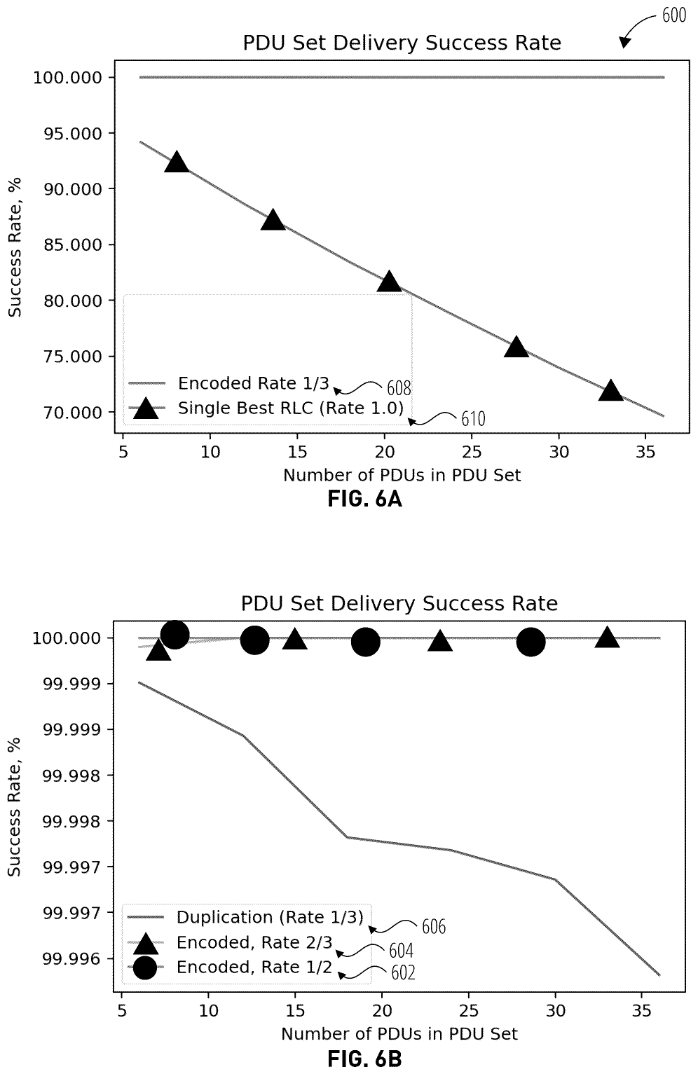

FIG. 6A and FIG. 6B illustrate graphs 600 of one dataset for the use of various PDCP PDU coding strategies and for various numbers of PDUs in the case of a stationary UE. Note that the difference between FIG. 6A and FIG. 6B is in y-axis scaling, and that the data corresponding to the various strategies covered in the dataset is placed on one and/or the other of FIG. 6A and FIG. 6B (where the y-axis scaling has been determined to be appropriate for the that data).

The network topology for the results illustrated in FIG. 6A and FIG. 6B may be assumed to be that illustrated in and described in relation to FIG. 5. It may be assumed that in the given stationary UE scenario, PER₁₌₁%, PER₂₌₁%, and PER₃₌₁%.

In the illustrated case, a use of packet-coded transmission with rate ½ 602 may provide a 100% success through all illustrated cases of number of PDUs, and a use of packet-coded transmission with rate ⅔ 604 may provide very close to a 100% success rate through all illustrated cases of number of PDUs. Note also that the packet-coded transmission with rate ⅔ 604 consumes on the order of two times fewer resources than an option for duplication 606, while providing better performance across the illustrated cases of number of PDUs.

Results for cases for a use of packet-coded transmission with rate ⅓ 608 and a use of single best RLC 610 for PDU transmission are also presented here.

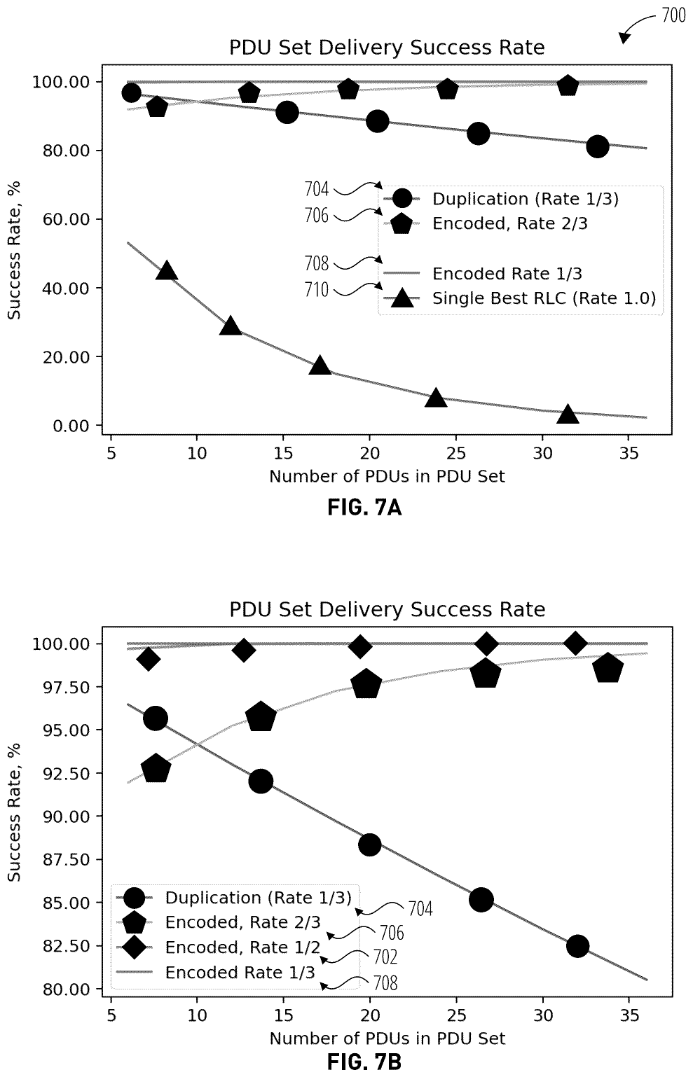

FIG. 7A and FIG. 7B illustrate graphs 700 of one dataset for the use of various PDCP PDU coding strategies and for various numbers of PDUs in the case of a highly mobile UE. Note that the difference between FIG. 7A and FIG. 7B is in y-axis scaling, and that the data corresponding to the various strategies covered in the dataset is placed on one and/or the other of FIG. 7A and FIG. 7B (where the y-axis scaling has been determined to be appropriate for the that data).

The network topology for the results illustrated in FIG. 7A and FIG. 7B may be assumed to be that illustrated in and described in relation to FIG. 5. It may be assumed that in the given highly mobile UE scenario, PER₁=10%, PER₂=20%, and PER₃=30%.

In the illustrated case, a use of packet-coded transmission with rate ½ 702 may provide close to a 100% success rate through all illustrated cases of number of PDUs, while case of the use of duplication 704 effectively fails. Note also that the use of packet-coded transmission with rate ½ 702 may in any event consume fewer radio resources than the use of duplication 704.

Results for cases for a use of packet-coded transmission with rate ⅔ 706, the use of packet-coded transmission with rate ⅓ 708, and use of a single best RLC 710 for PDU transmission are also presented here.

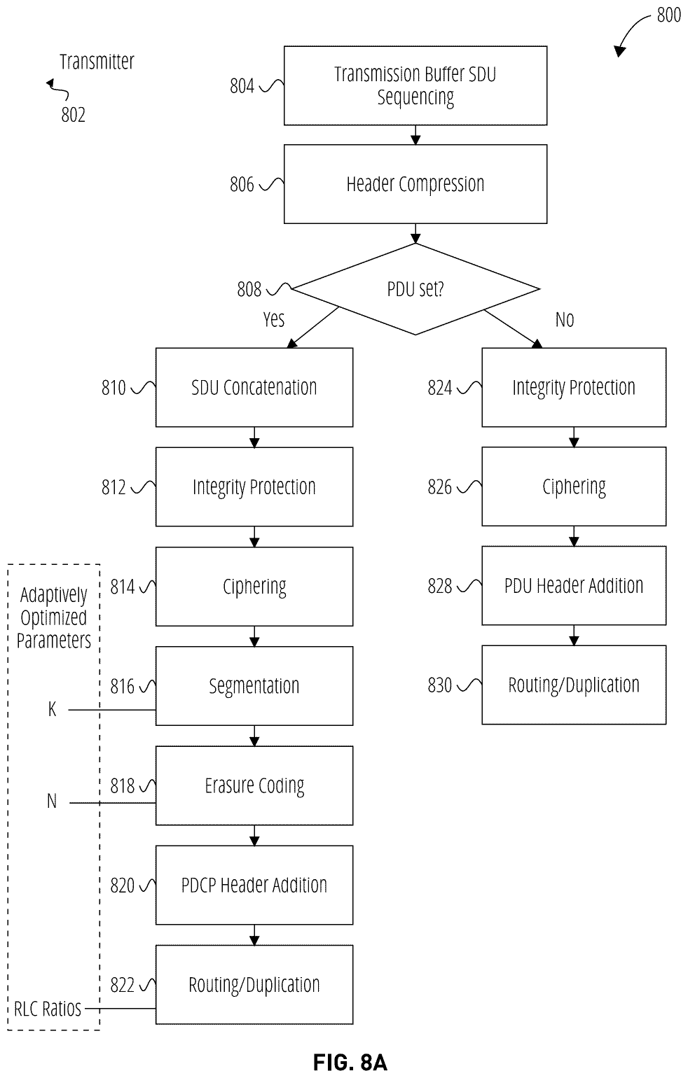

FIG. 8A and FIG. 8B illustrate functionalities of PDCP entities, according to embodiment discussed herein. FIG. 8A illustrates a flowchart 800 for the functionality of a PDCP entity at a transmitter 802, according to embodiments discussed herein.

First, the PDCP entity begins with transmission buffer SDU sequencing 804 for any received PDCP SDUs. Then, the PDCP entity performs header compression 806.

The PDCP entity then determines 808 whether or not the SDUs are for a PDU set.

The portion of the flowchart for the case where the PDCP entity determines 808 that the SDUs are for a PDU set is now discussed. The PDCP entity performs SDU concatenation 810 by concatenating together the SDUs for the PDU set.

The PDCP entity may then perform integrity protection 812 for the concatenated SDU set. This may be done by generating an authentication code (e.g., a message authentication code for data integrity (MAC-I)) for the plurality of SDUs to be used in the concatenated SDU set. Then, the PDCP entity may concatenate the authentication code together with the plurality of SDUs within the concatenated SDU set.

The PDCP entity may then perform ciphering 814 across the concatenated SDU set.

The PDCP entity may then perform segmentation 816 of the concatenated SDU set. This segmentation 816 may result in a number K of systematic PDUs of the PDU set, where each systematic PDU includes part of the data that was included in the concatenated SDU set. Note that there is no requirement that this segmentation 816 occur at the original boundaries of the SDUs for the PDU set.

The PDCP entity may then perform an erasure coding 818 across the K systematic PDUs. The erasure coding 818 may be, for example, a Reed-Solomon erasure encoding across the K systematic PDUs. The erasure coding 818 may generate a number of redundant PDUs such that the total number of systematic PDUs in addition to the total number of redundant PDUs makes for a total of N PDUs of the PDU set (where the number of redundant PDUs is thus understood to be N-K).

The PDCP entity may then perform PDCP header addition 820 for each of the N PDUs of the PDU set.

The PDCP entity may then perform routing/duplication 822 of the N PDUs across one or more RLC entities for transmission purposes. In the event that the transmitter is a UE, this may mean that each of the N PDUs is transmitted to a sub-cluster serving the UE that corresponds to a correspondingly selected RLC entity. In the event that the transmitter is a network entity (e.g., a cluster of base stations), this may mean that each of the N PDUs is distributed to a sub-cluster of the cluster of base stations corresponding to a correspondingly selected RLC entity for transmission to a UE through that sub-cluster. Note that in some cases, duplication of one or more of the PDUs of the PDU set may be used.

The portion of the flowchart for the case where the PDCP entity determines 808 that the SDUs are not for a PDU set is now discussed. The PDCP entity may perform integrity protection 824, ciphering 826, and/or PDU header addition 828 for the SDUs to generate PDUs corresponding to the PDCP SDUs (and where these PDUs are not part of a formal PDU set as discussed herein). Then, the PDCP entity perform routing/duplication 830 for these PDUs.

FIG. 8B illustrates a flowchart 832 for a functionality of a PDCP entity at a receiver 834, according to embodiments discussed herein. Note that the flowchart 832 proceeds in order from the bottom of FIG. 8B on to the top of FIG. 8B.

First, the PDCP entity may perform PDCP header removal 836 across received PDUs. These received PDUs are then placed in a reception buffer 838.

The PDCP entity may then determines 840 whether or not the PDUs are a PDU set.

The portion of the flowchart for the case where the PDCP entity determines 808 that the PDUs are a PDU set is now discussed. The PDCP entity may then perform erasure decoding 842 across the received PDUs such that a set of K systematic PDUs of the PDU set is reconstructed. The erasure decoding 842 may be, for example, a Reed-Solomon erasure decoding. The erasure decoding 842 may occur across a number (at least N-K, where N represents the number of PDUs in the PDU set as transmitted by the transmitter 802) of PDUs of the PDU set to arrive back at K systematic PDUs.

The PDCP entity may then perform assembly 844 of the K systematic PDUs. This (re)assembly may represent a concatenated SDU set as originally understood at the transmitter 802.

The PDCP entity may then perform deciphering 846 of the concatenated SDU set.

The PDCP entity may then perform integrity verification 848 for the concatenated SDU set. This may be done using an authentication code (e.g., a MAC-I)) for the plurality of SDUs used in the concatenated SDU set that is (also) found in the concatenated SDU set.

The PDCP entity may then perform decomposition 850 of the concatenated SDU set back into individual SDUs.

The portion of the flowchart for the case where the PDCP entity determines 808 that the PDUs are not a PDU set is now discussed. The PDCP entity may perform deciphering 856, integrity verification 858, and duplication discard 860 for the PDUs to generate SDUs corresponding to the PDUs.

For the remainder of the flowchart 832, the procedure is the same whether or not the received PDUs were of a same PDU set. The PDCP entity re-ordering 852 the SDUs as necessary. Then, the PDCP entity performs header decompression 854 on these SDUs.

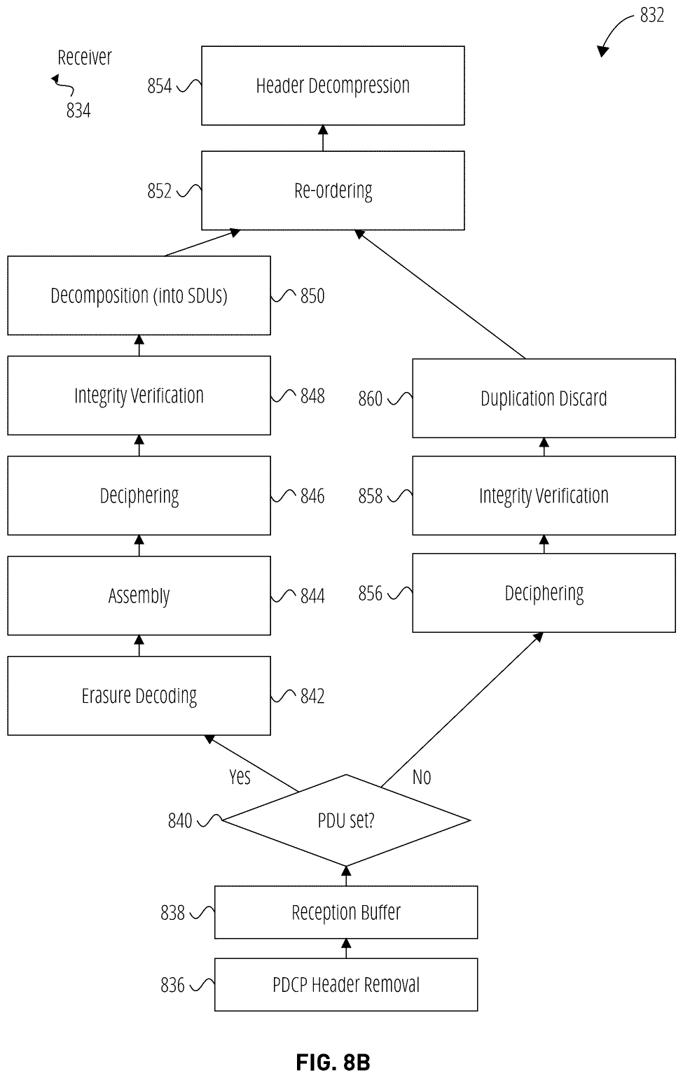

FIG. 9A and FIG. 9B taken together illustrate differences between first PDCP entity processing as used in prior PDCP entities and second PDCP entity processing as used by improved PDCP entities as disclosed herein. FIG. 9A illustrates a diagram 900 corresponding to the prior PDCP entities, while FIG. 9B illustrates a diagram 936 corresponding to improved PDCP entities.

The diagram 900 of FIG. 9A illustrates a set of SDUs 902 that undergo 5G PDCP processing 904. The SDUs 902 include a first SDU 906, a second SDU 908, a third SDU 910, a fourth SDU 912, a fifth SDU 914, and a sixth SDU 916. As shown, the first SDU 906, the second SDU 908, and the third SDU 910 are for a first PDU set 918, and the fifth SDU 914 and the sixth SDU 916 are for a second PDU set 920.

As shown, as a result of the 5G PDCP processing 904, the SDUs 902 are processed into PDUs 922 according to a one-to-one correspondence. The first SDU 906 is processed into the first PDU 924, the second SDU 908 is processed into the second PDU 926, the third SDU 910 is processed into the third PDU 928, the fourth SDU 912 is processed into the fourth PDU 930, the fifth SDU 914 is processed into the fifth PDU 932, and the sixth SDU 916 is processed into the sixth PDU 934.

Note that under the 5G PDCP processing 904, the processing of an SDU that is for a PDU set (e.g., the first SDU 906 or the fifth SDU 914) is equivalent to the processing that occurs for an SDU that is not for a PDU set (e.g., the fourth SDU 912). No specialized treatment for SDUs for a PDU set occurs.

The diagram 936 of FIG. 9B illustrates a set of SDUs 938 that undergo improved PDCP processing 940 corresponding to embodiments disclosed herein. The SDUs 938 include a first SDU 942, a second SDU 944, a third SDU 946, a fourth SDU 948, a fifth SDU 950, and a sixth SDU 952. As shown, the first SDU 942, the second SDU 944, and the third SDU 946 are for a first PDU set 918, and the fifth SDU 950 and the sixth SDU 952 are for a second PDU set 920.

As shown, as a result of the improved PDCP processing 940, the SDUs 938 are processed into a number of PDUs 958 that is not necessarily the same as the number of the SDUs 938 (there is no expectation of a one-to-one correspondence between SDUs and PDUs in all circumstances). This may occur due to the use of embodiments for the processing of SDUs for PDU sets as described herein, which do not require a one-to-one correspondence between SDUs and PDUs.

For example, as the first SDU 942, the second SDU 944, and the third SDU 946 are for the first PDU set 954, they are processed according to PDCP procedures for SDUs that are for a same PDU set (e.g., as these procedures are discussed herein). In the illustrated case, this processing results in two PDUs, the first PDU 960 and the second PDU 962, that make up the first PDU set 954. Further, as the fifth SDU 950 and the sixth SDU 952 are for the second PDU set 956, they are processed according to PDCP procedures for SDUs that are for a same PDU set (e.g., as these procedures are discussed herein). In the illustrated case, this processing results in four PDUs, the fourth PDU 966, the fifth PDU 968, the sixth PDU 970, and the seventh PDU 972, that make up the second PDU set 956.

Note that, as shown, the conception of the PDU set entities in play remains the same both before and after the improved PDCP processing 940 (the improved PDCP processing 940 does not modify the number of PDU sets).

Note further that SDUs that are not for a PDU set may be processed on a one-to-one basis. For example, as illustrated the fourth SDU 948 (which is not for a PDCP set) is processed into a third PDU 964

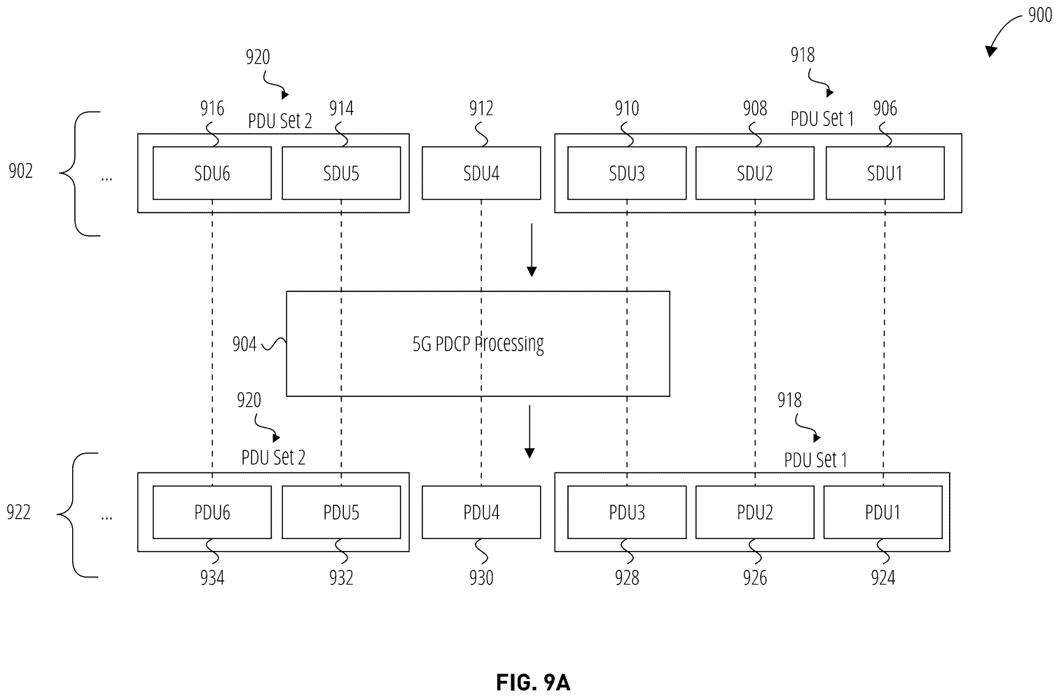

FIG. 10 illustrates a diagram 1000 of PDCP processing at a PDCP entity as may be used by a transmitter, according to embodiments herein. In some embodiments, the transmitter may be a UE that uses the PDCP entity. In some embodiments, the transmitter may be (collectively) a cluster of base stations that uses the PDCP entity.

As illustrated, a first SDU 1002, a second SDU 1004, and a third SDU 1006 are being processed at the PDCP layer for transmission. As illustrated, each of the first SDU 1002, the second SDU 1004, and the third SDU 1006 are made up of a header and a payload. The first SDU 1002, the second SDU 1004, and the third SDU 1006 are SDUs for a same PDU set 1008.

Each of the SDUs for the PDU set 1008 (the first SDU 1002, the second SDU 1004, and the third SDU 1006) are then concatenated together to generate a concatenated SDU set 1010. In some embodiments, as illustrated, an authentication code (e.g., the MAC-I 1012) may be generated for the plurality of SDUs in the concatenated SDU set 1010 and concatenated with the plurality of SDUs in the concatenated SDU set 1010. Accordingly, it will be understood that the diagram 1000 ultimately proceeds with the MAC-I 1012 in the concatenated SDU set 1010, a concatenated SDU set may or may not include an authentication code, depending on the embodiment.

In some embodiments, once generated, the concatenated SDU set 1010 may be ciphered (not expressly illustrated in the diagram 1000).

The diagram 1000 then proceeds to illustrate that the concatenated SDU set 1010 is segmented into a number K of systematic PDUs 1014 of the PDU set 1008. Each of the systematic PDUs 1014 includes a portion of the concatenated SDU set 1010. Each of the systematic PDUs 1014 may be of a same size. In the illustrated case, K=3; however, in other embodiments, K could take other values (e.g., K=1, K=2, K=4, K=5, and so on).

An encoding is then performed with the systematic PDUs 1014 to generate a number N-K redundant PDUs (where N represents the total number of PDUs in the PDU set 1008 as will be ultimately transmitted by the transmitter). The encoding performed with the systematic PDUs 1014 to generate the redundant PDUs 1016 may be, for example, a Reed-Solomon encoding as discussed herein. The result of the encoding is that there are N total PDUs for transmission.

Then, PDCP headers 1018 may be added to each of the N PDUs, which are then transmitted. The transmission of the N PDUs may be distributed across one or more RLC entities of the transmitter (e.g., in a manner discussed elsewhere herein).

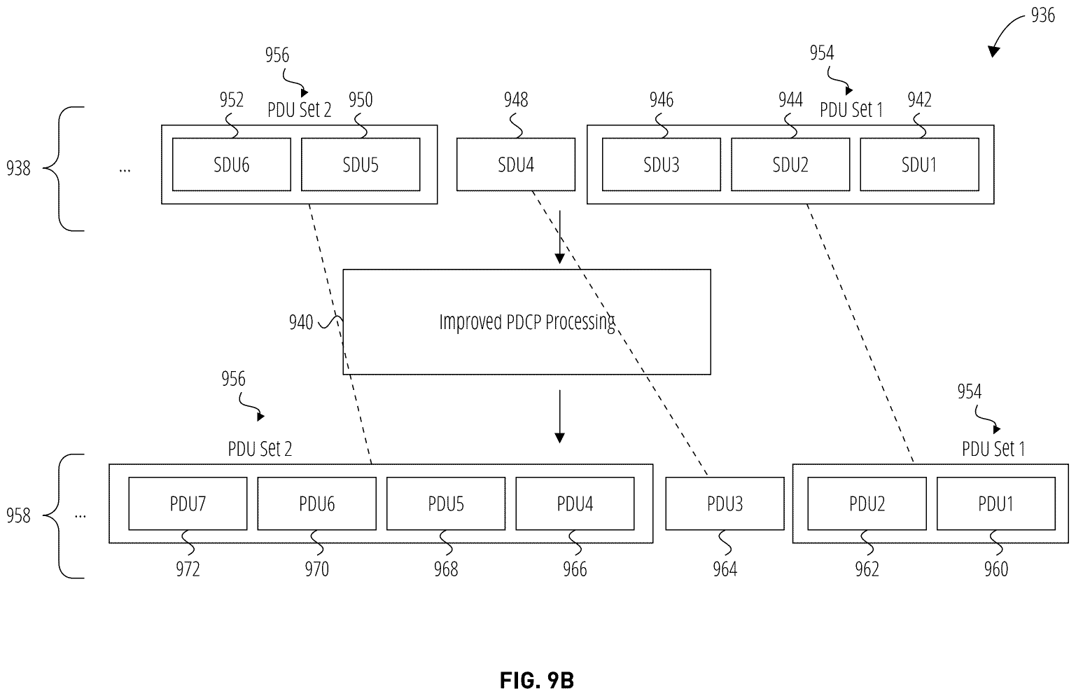

FIG. 11 illustrates a diagram 1100 of PDCP processing at a PDCP entity as may be used by a receiver, according to embodiments herein. In some embodiments, the receiver may be a UE that uses the PDCP entity. In some embodiments, the receiver may be (collectively) a cluster of base stations that uses the PDCP entity.

As illustrated, each of the first PDU 1102, the second PDU 1104, the third PDU 1106, the fourth PDU 1108, the fifth PDU 1110, the sixth PDU 1112, the seventh PDU 1114, the eighth PDU 1116, and the ninth PDU 1118 are received at the receiver (and may be received/considered by the receiver in that order). Each of these PDUs is associated (e.g., in a PDCP header for the PDU) with a value K denoting the number of systematic PDUs within any PDU set to which the PDU belongs. Note that, as in the case of the first PDU 1102 and the seventh PDU 1114, K=1, indicating that these PDUs represent individual PDUs not belonging to any PDU set. For those PDUs with K>1 (e.g., PDUs that are PDUs of a PDU set), another value S (e.g., as may be found in a PDCP header for the PDU) represents an index for the PDU set to which that PDU belongs. This index allows the receiver to match/correspond received PDUs to other PDUs of that same PDU set (if applicable).

As illustrated, the first PDU 1102 is treated first. As K=1 for the first PDU 1102, the receiver knows that it is an individual PDU that does not belong to any PDU set. Thus, no assembly 1120 is needed with respect to the first PDU 1102, and the first PDU 1102 is passed through for formation of the first SDU 1126, as illustrated.

Then, the second PDU 1104 is treated. As K=3 for the second PDU 1104, the receiver knows the second PDU 1104 belongs to a PDU set having three systematic PDUs. Further, the receiver is aware that the index S of the PDU set is 2. Thus, the receiver is aware that when it receives three (unique) PDUs for S=2, it can decode the second concatenated SDU set 1122 that corresponds to the PDU set for S=2.

Then, the third PDU 11064 is treated. As K=3 for the third PDU 1106, the receiver knows the third PDU 1106 belongs to a PDU set having three systematic PDUs. Further, the receiver is aware that the index S of the PDU set is 1. Thus, the receiver is aware that when it receives three (unique) PDUs for S=1, it can decode the first concatenated SDU set 1124 that corresponds to the PDU set for S=1.

Then, the fourth PDU 1108 is treated. As S=2 for the fourth PDU 1108, the receiver knows the fourth PDU 1108 is in the same PDU set as the second PDU 1104 already received with S=2. Further, the transmitted identifies that the fourth PDU 1108 is different from the second PDU 1104 of this PDU set that was already received (P6≠P5, see illustration). Thus, the receiver understands that the fourth PDU 1108 may be used with the second PDU 1104 to decode the second concatenated SDU set 1122 that corresponds to the PDU set for S=2 once K=3 unique PDUs for the PDU set are received.

Then, the fifth PDU 1110 is treated. As S=2 for the fifth PDU 1110, the receiver knows the fifth PDU 1110 is in the same PDU set as the second PDU 1104 and the fourth PDU 1108 already received with S=2. Further, the transmitted identifies that the fifth PDU 1110 is different from the second PDU 1104 and the fourth PDU 1108 of this PDU set that were already received (P8≠P6≠P5, see illustration). Thus, the receiver understand that the fifth PDU 1110 may be used with the second PDU 1104 and the fourth PDU 1108 to decode the second concatenated SDU set 1122 that corresponds to the PDU set for S=2.

At this juncture, now that the transmitter has K=3 (unique) PDUs for the PDU set S=2 (the second PDU 1104, the fourth PDU 1108, and the fifth PDU 1110), the transmitter may proceed to decode the second concatenated SDU set 1122 for S=2 (using each of the second PDU 1104, the fourth PDU 1108, and the fifth PDU 1110 as received).

Then, the sixth PDU 1112 is treated. As S=1 for the sixth PDU 1112, the receiver knows the sixth PDU 1112 is in the same PDU set as the third PDU 1106 already received with S=1. Further, the transmitted identifies that the sixth PDU 1112 is different from the third PDU 1106 of this PDU set that was already received (P3≠P2, see illustration). Thus, the receiver understands that the sixth PDU 1112 may be used with the third PDU 1106 to decode the first concatenated SDU set 1124 that corresponds to the PDU set for S=1 once K=3 unique PDUs for the PDU set are received.

Then, the seventh PDU 1114 is treated. The seventh PDU 1114 is recognized as a duplicate of the first PDU 1102 (P1=P1, see illustration) and is thus discarded.

Then, the eighth PDU 1116 is treated. As S=1 for the eighth PDU 1116, the receiver knows the eighth PDU 1116 is in the same PDU set as the third PDU 1106 and the sixth PDU 1112 already received with S=1. Further, the transmitted identifies that the eighth PDU 1116 is different from the third PDU 1106 and the sixth PDU 1112 of this PDU set that were already received (P4≠P3≠P2, see illustration). Thus, the eighth PDU 1116 may be used with the third PDU 1106 and the sixth PDU 1112 to decode the first concatenated SDU set 1124 that corresponds to the PDU set for S=1.

At this juncture, now that the transmitter has K=3 (unique) PDUs for the PDU set S=1 (the third PDU 1106, the sixth PDU 1112, and the eighth PDU 1116), the transmitter may proceed to decode the first concatenated SDU set 1124 for S=1 (using each of the third PDU 1106, the sixth PDU 1112, and the eighth PDU 1116 as received).

Then, the ninth PDU 1118 is treated. As S=2 for the fifth PDU 1110, the receiver knows the fifth PDU 1110 is in the same PDU set as the second PDU 1104, the fourth PDU 1108, and the fifth PDU 1110 already received with S=2. Further, because K=3 for the PDU set S=2, and because the receiver has already received three unique PDUs for this PDU set (the second PDU 1104, the fourth PDU 1108, and the fifth PDU 1110) from which the second concatenated SDU set 1122 may be decoded, the ninth PDU 1118 is not strictly necessary. Accordingly, the ninth PDU 1118 is discarded.

In an alternative case, where the receiver failed to properly receive one of the second PDU 1104, the fourth PDU 1108, or the fifth PDU 1110, the ninth PDU 1118 could have acted as a replacement therefore. This would mean that K=3 PDUs of the PDU set for S=2 were still ultimately received, thereby allowing for the decoding of the second concatenated SDU set 1122 notwithstanding the earlier failed reception of the one of the second PDU 1104, the fourth PDU 1108, or the fifth PDU 1110.

The diagram 1000 illustrates that when K PDUs of a PDU set are received, decoding (e.g., erasure decoding) and assembly procedures may be performed (as has been discussed). This results in the decoding of the first concatenated SDU set 1124 and the second concatenated SDU set 1122.

Deciphering and/or integrity verification of the first concatenated SDU set 1124 and/or the second concatenated SDU set 1122 may be performed at this juncture. For example, the first concatenated SDU set 1124 and/or the second concatenated SDU set 1122 may be deciphered once decoded. Further, the receiver may retrieve an authentication code for the corresponding plurality of SDUs for either of the first concatenated SDU set 1124 and/or the second concatenated SDU set 1122 from the corresponding one of the first concatenated SDU set 1124 and/or the second concatenated SDU set 1122 and authenticate the corresponding plurality of SDUs using the authentication code.

Each of the first concatenated SDU set 1124 and the second concatenated SDU set 1122 are then decomposed into their individual SDUs. As illustrated, the first concatenated SDU set 1124 is decomposed into the second SDU 1128, the third SDU 1130, the fourth SDU 1132, and the fifth SDU 1134, while the second concatenated SDU set 1122 is decomposed into the sixth SDU 1136 and the seventh SDU 1138. No decomposition occurs corresponding to the first SDU 1126 as it was not part of a PDU set needing such decomposition.

Then, according to the sequencing of the SDUs, reordering and header decompression may be performed as necessary. As illustrated, the SDUs are re-ordered from the first SDU 1126 to the seventh SDU 1138 per the illustrated proper SDU sequencing. Header decompression may also be performed for each SDU.

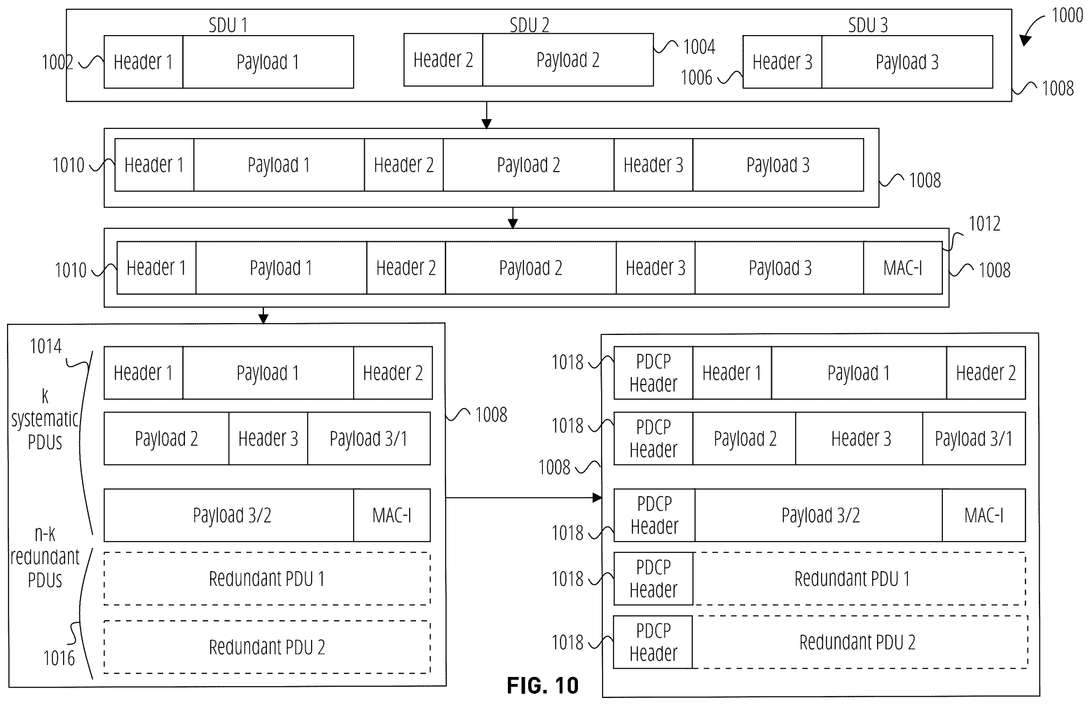

FIG. 12 illustrates a diagram 1200 of a protocol for PDU set encoding as may be used by a PDCP entity of a transmitter 1202, according to embodiments herein. As illustrated, the PDCP entity may be used to process a concatenated SDU set 1206 (e.g., as described herein) for transmission.

The PDCP entity may perform K selection 1204 to determine the number of systematic PDUs in the PDU set after the PDU set segmentation 1208, which is then performed accordingly.

The PDCP entity may also perform N selection 1210 to determine the number of total PDUs N for transmission. N may be selected in order to reach a desired K/N coding rate for a PDU erasure coding 1212 for the PDU set. The PDU erasure coding 1212 encodes over the K systematic PDUs to generate a number of N-K redundant PDUs such that there are N total encoded PDUs for the PDU set, as illustrated.

At PDCP header addition 1214, PDCP headers are added to each of the N encoded PDUs. Such a PDCP header may include PDCP PDU ID, a K value, and/or a PDU Set ID S (e.g., if K>1).

As illustrated, RLC ratio(s) selection 1216 is then performed. As part of the RLC ratio(s) selection 1216, the PDCP entity may select ratio(s) to be used during PDU routing 1222 to distribute the packets/PDUs across RLCs used by the transmitter.

In the case that the transmitter 1202 is a UE, network signaling 1218 may be received that includes one or more recommended ratios 1220 (e.g., one or more recommended values for RLC ratios), which may be used for purpose of the RLC ratio(s) selection 1216. This signaling may be considered as a part of Layer 3 (L3) scheduling.

Then, during PDU routing 1222 the packets/PDUs are distributed across RLCs used by the transmitter. The illustrated case uses the RLC entities 1224 1 . . . M.

In some embodiments involving the use of recommended ratios 1220, recommended values for RLC ratios may be provided for a particular radio bearer. These recommendations may reflect QoS requirements for the radio bearer. For example, for radio bearers with low-latency traffic, the ratios may be based on a short-term capacity prediction for corresponding sub-carriers. The recommended values of the RLC ratios may be provided within a radio resource control (RRC) control message or using an agreement protocol mechanism.

The manner of selecting the RLC ratios at the RLC ratio(s) selection 1216 stage (including the determination of whether or not to take into account the values recommended by a network, where applicable) may be up to the device implementation.

In some embodiments, a device making the RLC ratio(s) selection 1216 may take into account instantaneous and/or statistical RLC buffer status information, a history of service, layer 1 (L1) measurements, and/or layer 3 (L3) measurements. A timing to apply the RLC ratio(s) selection 1216 may also be made at the device, and may be according to particular device implementation.

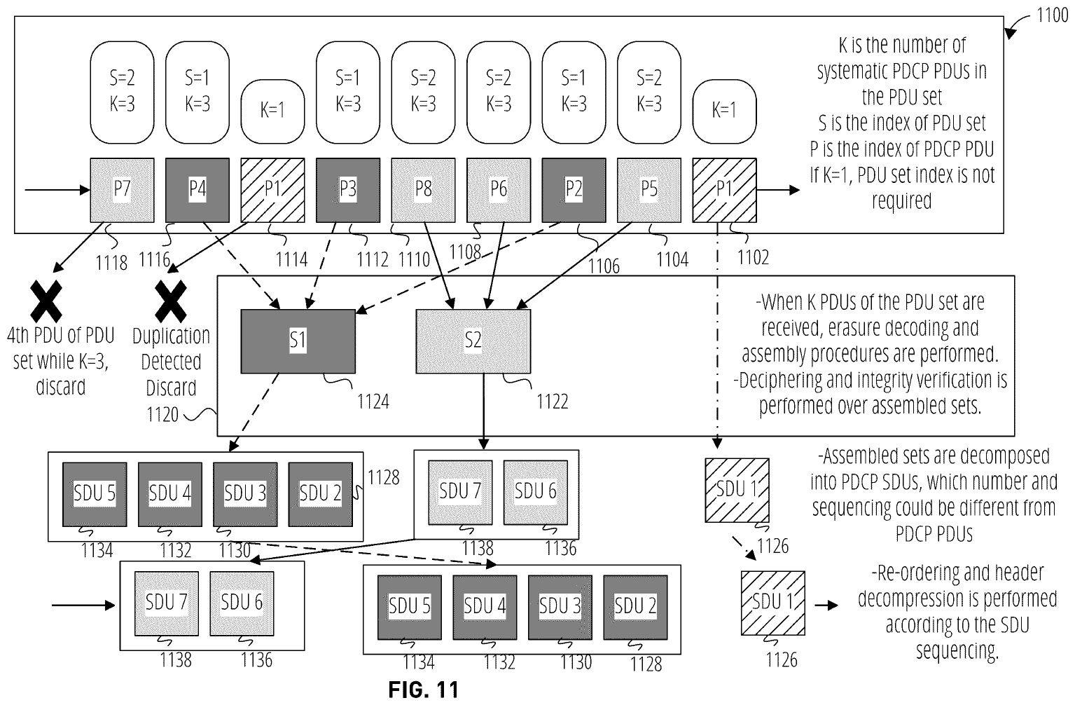

FIG. 13 illustrates a diagram 1300 for the non-integrated handling of PDU sets using virtual PDU sets by a PDCP entity at a transmitter, according to embodiments herein. In some embodiments, the transmitter may be a UE that uses the PDCP entity. In some embodiments, the transmitter may be (collectively) a cluster of base stations that uses the PDCP entity.

In some embodiments, a PSIHI for a PDU set may be equal to FALSE. This may indicate that, for example, packets/SDUs of the PDU set may have value for the application independently. The diagram 1300 illustrates a case where there are SDUs 1302 for a PDU set that uses PSIHI=FALSE.

In some such cases, a virtual PDU set may be used. A virtual PDU set may correspond to some subset the SDUs for the PDU set that may then be jointly encoded at PDCP layer prior to transmission (e.g., by an erasure coding, as discussed herein).

For example, the diagram 1300 illustrates that, the SDUs 1302 for the PDU set may be split such that they correspond to multiple virtual PDU sets. The transmitter may, in some cases, determine 1304 a number of virtual PDU sets to use for this purpose. As illustrated, this determination may be based on, for example, a target PDU error rate and/or a packet error rate at lower layers.

The transmitter splits 1306 the SDUs 1302 into the individual groupings for the various virtual PDU sets. The diagram 1300 corresponds to a case where three virtual PDU sets are used. As illustrated, the SDUs 1302 are split into a first subset 1308, a second subset 1310, and a third subset 1312, with the first subset 1308 understood as a set of SDUs for a first virtual PDU set 1314, the second subset 1310 understood as a set of SDUs for second virtual PDU set 1316, and the third subset 1312 understood as a set of SDUs for a third virtual PDU set 1318.

Then, PDCP PDU set processing 1320 as discussed herein (e.g., a PDCP processing procedure for SDUs for a PDU set, as discussed herein) may be (independently) performed for the SDUs for each virtual PDU set.

In some embodiments, at the (corresponding) PDCP entity of the receiver, the virtual PDU sets may be processed as individual PDU sets, and then combined back into the original grouping of SDUs 1302 for the original PDU set. To facilitate this, information about any split into virtual PDU sets may be relayed by the transmitter PDCP layer to the receiver PDCP layer (e.g., over a transmit (Tx) PDCP to receive (Rx) PDCP link that may not be visible above the PDCP layer).

In uplink, a specific sub-module of a PDCP layer may be introduced to adaptively select a number of virtual PDU sets for each PDU set (with PSIHI=FALSE). In downlink, virtual PDU sets may be formed based on available SDUs of the same PDU set in a PDCP buffer.

In some embodiments, each virtual PDU set may be processed by the PDCP layer independently, using the same flow as for PDU sets (e.g., as described herein). In such cases, provided parameters N, K etc. of the PDU coding may be optimized individually for each virtual PDU set.

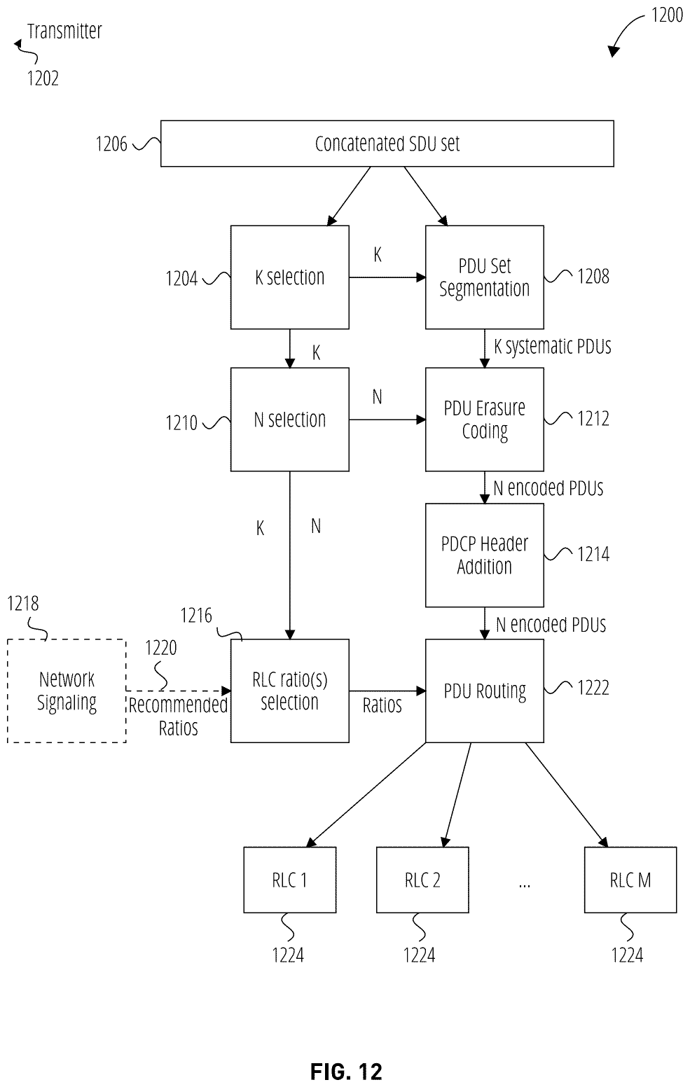

FIG. 14 illustrates a method 1400 of a UE that is served by a cluster of base stations for PDCP processing for a PDCP entity, according to embodiments discussed herein. The method 1400 includes generating 1402 a concatenated SDU set by concatenating a plurality of SDUs for a PDU set. The method 1400 further includes segmenting 1404 the concatenated SDU set into one or more systematic PDUs of the PDU set. The method 1400 further includes performing 1406 an encoding with the one or more systematic PDUs to generate one or more redundant PDUs of the PDU set. The method 1400 further includes distributing 1408 the one or more systematic PDUs and the one or more redundant PDUs across one or more RLC entities for transmission to one or more sub-clusters of the cluster of base stations that correspond to the one or more RLC entities.

In some embodiments of the method 1400, the concatenated SDU set is further generated by: generating an authentication code for the plurality of SDUs; and concatenating, within the concatenated SDU set, the authentication code with the plurality of SDUs.

In some embodiments, the method 1400 further includes ciphering the concatenated SDU set prior to segmenting the concatenated SDU set.

In some embodiments of the method 1400, the encoding comprises a Reed-Solomon erasure encoding.

In some embodiments of the method 1400, each of the one or more systematic PDUs and each of the one or more redundant PDUs is of a same size.

In some embodiments, the method 1400 further includes determining a number of the one or more systematic PDUs.

In some embodiments, the method 1400 further includes determining a total number of the one or more systematic PDUs and the redundant PDUs.

In some embodiments, the method 1400 further includes selecting an RLC ratio, wherein the one or more systematic PDUs and the one or more redundant PDUs are distributed across the RLC entities according to the RLC ratio. In some such embodiments, the method 1400 further includes receiving, from the cluster, a recommended RLC ratio, wherein the RLC ratio is selected by the UE according to the recommended RLC ratio.

In some embodiments of the method 1400, the PDU set comprises a virtual PDU set.

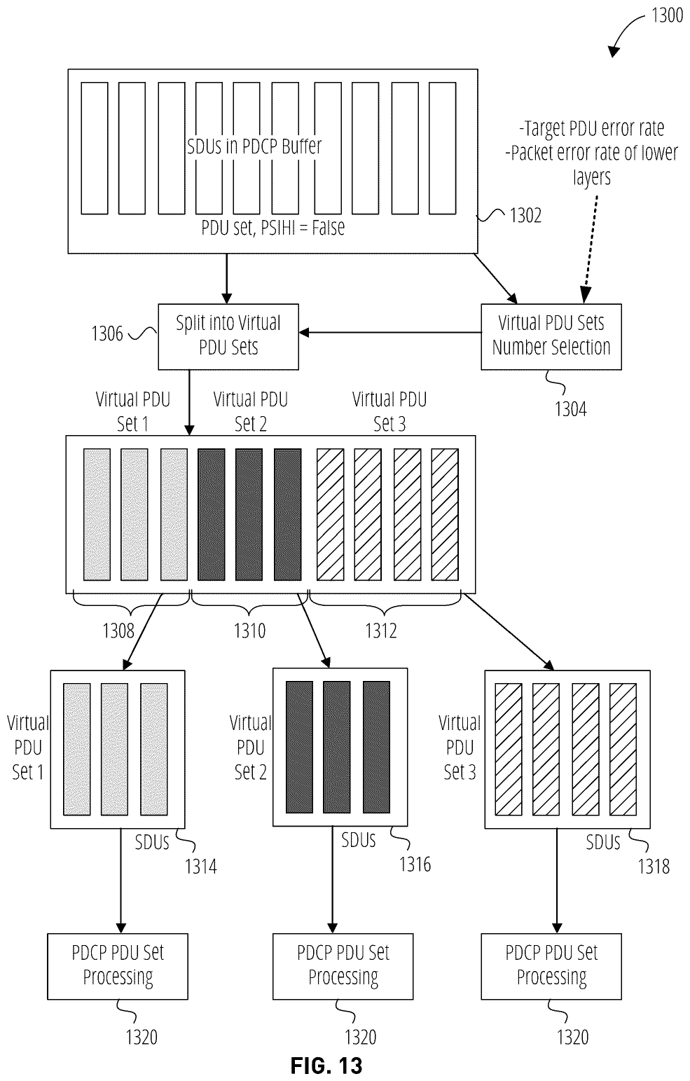

FIG. 15 illustrates a method 1500 of a UE that is served by a cluster of base stations for PDCP processing for a PDCP entity, according to embodiments discussed herein. The method 1500 includes receiving 1502, from one or more RLC entities corresponding to one or more sub-clusters of the cluster of base stations, one or more PDUs of a PDU set. The method 1500 further includes performing 1504, based on a determination that a number of the one or more PDUs is greater than or equal to a number of systematic PDUs for the PDU set, a decoding with the one or more PDUs of the PDU set to generate a concatenated SDU set. The method 1500 further includes decomposing 1506 the concatenated SDU set into a plurality of SDUs for the PDU set. The method 1500 further includes providing 1508 the plurality of SDUs to a higher layer protocol entity of the UE.

In some embodiments, the method 1500 further includes retrieving an authentication code for the plurality of SDUs from the concatenated SDU set; and authenticating the plurality of SDUs using the authentication code.

In some embodiments, the method 1500 further includes deciphering the concatenated SDU set prior to decomposing the concatenated SDU set.

In some embodiments of the method 1500, the decoding comprises a Reed-Solomon erasure decoding.

In some embodiments of the method 1500, each of the one or more PDUs is of a same size.

In some embodiments of the method 1500, the PDU set comprises a virtual PDU set.

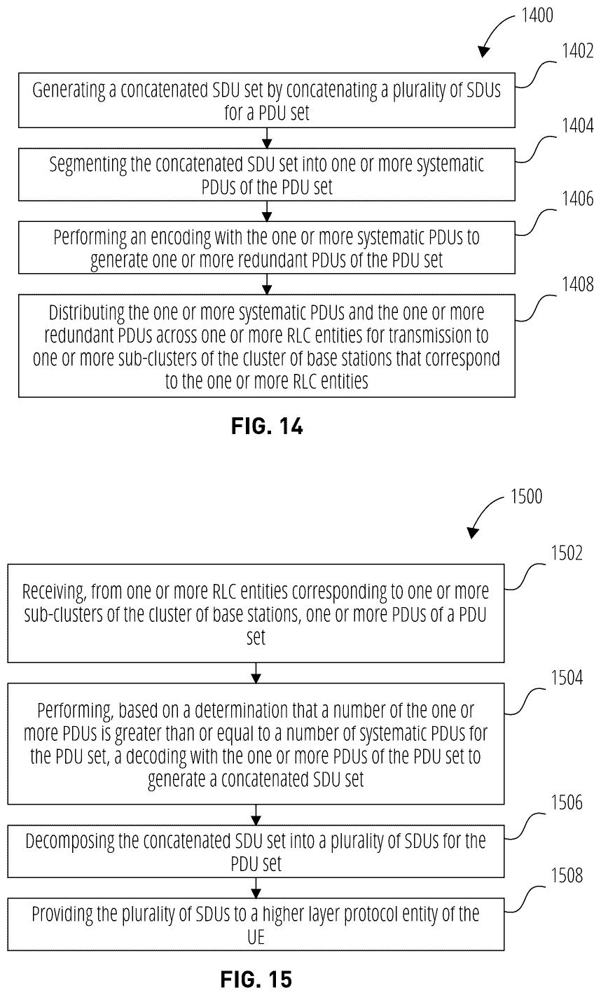

FIG. 16 illustrates a method 1600 of a cluster of base stations that is serving a UE for PDCP processing for a PDCP entity, according to embodiments discussed herein. The method 1600 includes generating 1602 a concatenated SDU set by concatenating a plurality of SDUs for a PDU set. The method 1600 further includes segmenting 1604 the concatenated SDU set into one or more systematic PDUs of the PDU set. The method 1600 further includes performing 1606 an encoding with the one or more systematic PDUs to generate one or more redundant PDUs of the PDU set. The method 1600 further includes distributing 1608 the one or more systematic PDUs and the one or more redundant PDUs across one or more RLC entities corresponding to one or more sub-clusters of the cluster of base stations for transmission to the UE.

In some embodiments, the method 1600 further includes generating an authentication code for the plurality of SDUs; and concatenating, within the concatenated SDU set, the authentication code with the plurality of SDUs.

In some embodiments, the method 1600 further includes ciphering the concatenated SDU set prior to segmenting the concatenated SDU set.

In some embodiments of the method 1600, the encoding comprises a Reed-Solomon erasure encoding.

In some embodiments of the method 1600, each of the one or more systematic PDUs and each of the one or more redundant PDUs is of a same size.

In some embodiments, the method 1600 further includes determining a number of the one or more systematic PDUs.

In some embodiments, the method 1600 further includes determining a total number of the one or more systematic PDUs and the redundant PDUs.

In some embodiments, the method 1600 further includes selecting an RLC ratio, wherein the one or more systematic PDUs and the one or more redundant PDUs are distributed across the RLC entities according to the RLC ratio. In some such embodiments, the method 1600 further includes receiving, from the UE, a recommended RLC ratio, wherein the RLC ratio is selected by the PDCP entity according to the recommended RLC ratio.

In some embodiments, the method 1600 further includes receiving, from a CCF for the cluster of base stations, an RLC ratio, wherein the one or more systematic PDUs and the one or more redundant PDUs are distributed across the RLC entities according to the RLC ratio.

In some embodiments of the method 1600, the PDU set comprises a virtual PDU set.

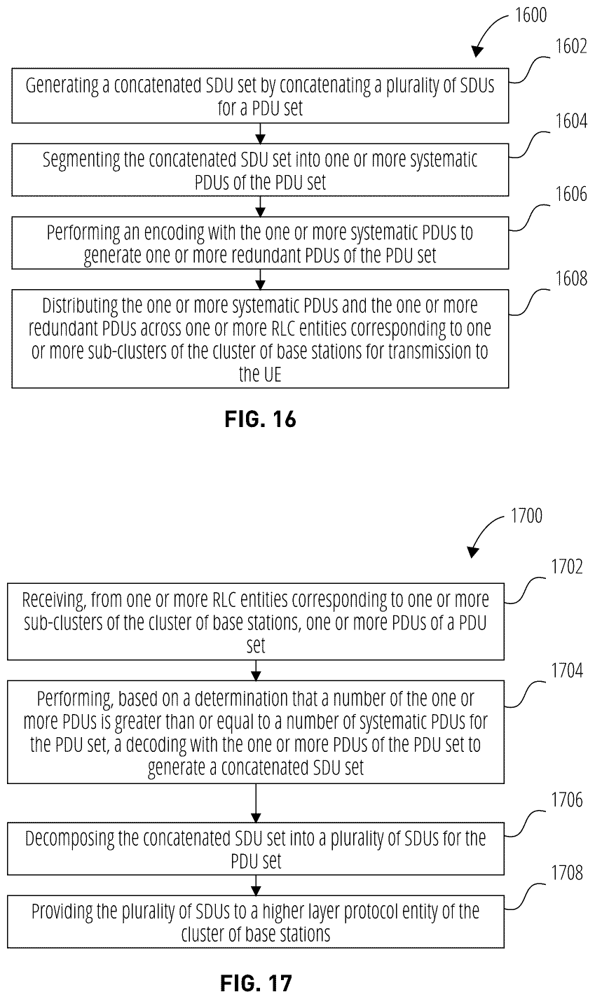

FIG. 17 illustrates a method 1700 of a cluster of base stations that is serving a UE for PDCP processing for a PDCP entity, according to embodiments discussed herein. The method 1700 includes receiving 1702, from one or more RLC entities corresponding to one or more sub-clusters of the cluster of base stations, one or more PDUs of a PDU set. The method 1700 further includes performing 1704, based on a determination that a number of the one or more PDUs is greater than or equal to a number of systematic PDUs for the PDU set, a decoding with the one or more PDUs of the PDU set to generate a concatenated SDU set. The method 1700 further includes decomposing 1706 the concatenated SDU set into a plurality of SDUs for the PDU set. The method 1700 further includes providing 1708 the plurality of SDUs to a higher layer protocol entity of the cluster of base stations.

In some embodiments, the method 1700 further includes retrieving an authentication code for the plurality of SDUs from the concatenated SDU set; and authenticating the plurality of SDUs using the authentication code.

In some embodiments, the method 1700 further includes deciphering the concatenated SDU set prior to decomposing the concatenated SDU set.

In some embodiments of the method 1700, the decoding comprises a Reed-Solomon erasure decoding.

In some embodiments of the method 1700, each of the one or more PDUs is of a same size.

In some embodiments of the method 1700, the PDU set comprises a virtual PDU set.

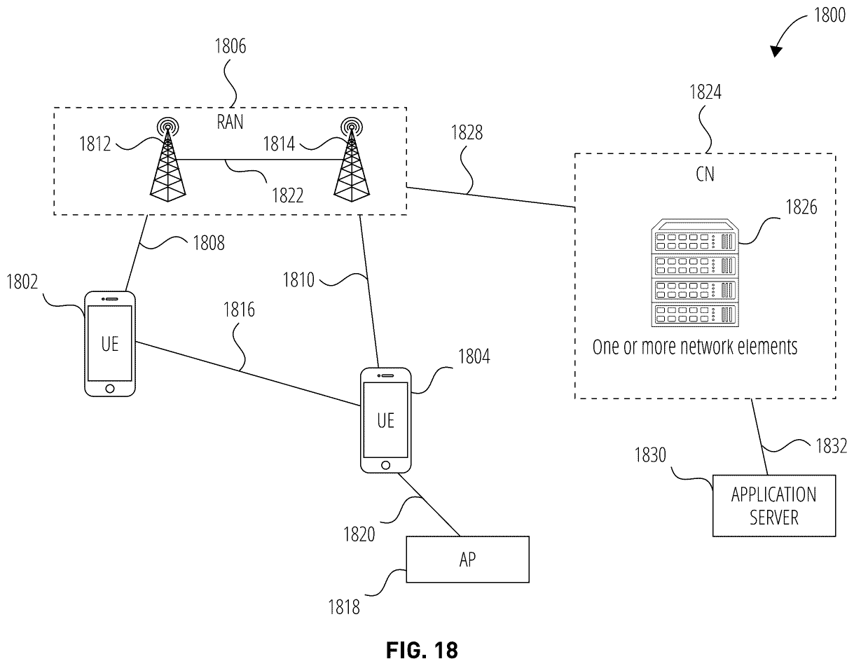

FIG. 18 illustrates an example architecture of a wireless communication system 1800, according to embodiments disclosed herein. The following description is provided for an example wireless communication system 1800 that operates in conjunction with the LTE system standards and/or 5G or NR system standards as provided by 3GPP technical specifications.

As shown by FIG. 18, the wireless communication system 1800 includes UE 1802 and UE 1804 (although any number of UEs may be used). In this example, the UE 1802 and the UE 1804 are illustrated as smartphones (e.g., handheld touchscreen mobile computing devices connectable to one or more cellular networks), but may also comprise any mobile or non-mobile computing device configured for wireless communication.

The UE 1802 and UE 1804 may be configured to communicatively couple with a RAN 1806. In embodiments, the RAN 1806 may be NG-RAN, E-UTRAN, etc. The UE 1802 and UE 1804 utilize connections (or channels) (shown as connection 1808 and connection 1810, respectively) with the RAN 1806, each of which comprises a physical communications interface. The RAN 1806 can include one or more base stations (such as base station 1812 and base station 1814) that enable the connection 1808 and connection 1810.

In this example, the connection 1808 and connection 1810 are air interfaces to enable such communicative coupling, and may be consistent with RAT(s) used by the RAN 1806, such as, for example, an LTE and/or NR.

In some embodiments, the UE 1802 and UE 1804 may also directly exchange communication data via a sidelink interface 1816. The UE 1804 is shown to be configured to access an access point (shown as AP 1818) via connection 1820. By way of example, the connection 1820 can comprise a local wireless connection, such as a connection consistent with any IEEE 802.11 protocol, wherein the AP 1818 may comprise a Wi-Fi® router. In this example, the AP 1818 may be connected to another network (for example, the Internet) without going through a CN 1824.

In embodiments, the UE 1802 and UE 1804 can be configured to communicate using orthogonal frequency division multiplexing (OFDM) communication signals with each other or with the base station 1812 and/or the base station 1814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1812 or base station 1814 may be implemented as one or more software entities running on server computers as part of a virtual network. In addition, or in other embodiments, the base station 1812 or base station 1814 may be configured to communicate with one another via interface 1822. In embodiments where the wireless communication system 1800 is an LTE system (e.g., when the CN 1824 is an EPC), the interface 1822 may be an X2 interface. The X2 interface may be defined between two or more base stations (e.g., two or more eNBs and the like) that connect to an EPC, and/or between two eNBs connecting to the EPC. In embodiments where the wireless communication system 1800 is an NR system (e.g., when CN 1824 is a 5GC), the interface 1822 may be an Xn interface. The Xn interface is defined between two or more base stations (e.g., two or more gNBs and the like) that connect to 5GC, between a base station 1812 (e.g., a gNB) connecting to 5GC and an eNB, and/or between two eNBs connecting to 5GC (e.g., CN 1824).

The RAN 1806 is shown to be communicatively coupled to the CN 1824. The CN 1824 may comprise one or more network elements 1826, which are configured to offer various data and telecommunications services to customers/subscribers (e.g., users of UE 1802 and UE 1804) who are connected to the CN 1824 via the RAN 1806. The components of the CN 1824 may be implemented in one physical device or separate physical devices including components to read and execute instructions from a machine-readable or computer-readable medium (e.g., a non-transitory machine-readable storage medium).

In embodiments, the CN 1824 may be an EPC, and the RAN 1806 may be connected with the CN 1824 via an S1 interface 1828. In embodiments, the S1 interface 1828 may be split into two parts, an S1 user plane (S1-U) interface, which carries traffic data between the base station 1812 or base station 1814 and a serving gateway (S-GW), and the S1-MME interface, which is a signaling interface between the base station 1812 or base station 1814 and mobility management entities (MMEs).

In embodiments, the CN 1824 may be a 5GC, and the RAN 1806 may be connected with the CN 1824 via an NG interface 1828. In embodiments, the NG interface 1828 may be split into two parts, an NG user plane (NG-U) interface, which carries traffic data between the base station 1812 or base station 1814 and a user plane function (UPF), and the S1 control plane (NG-C) interface, which is a signaling interface between the base station 1812 or base station 1814 and access and mobility management functions (AMFs).

Generally, an application server 1830 may be an element offering applications that use internet protocol (IP) bearer resources with the CN 1824 (e.g., packet switched data services). The application server 1830 can also be configured to support one or more communication services (e.g., VoIP sessions, group communication sessions, etc.) for the UE 1802 and UE 1804 via the CN 1824. The application server 1830 may communicate with the CN 1824 through an IP communications interface 1832.

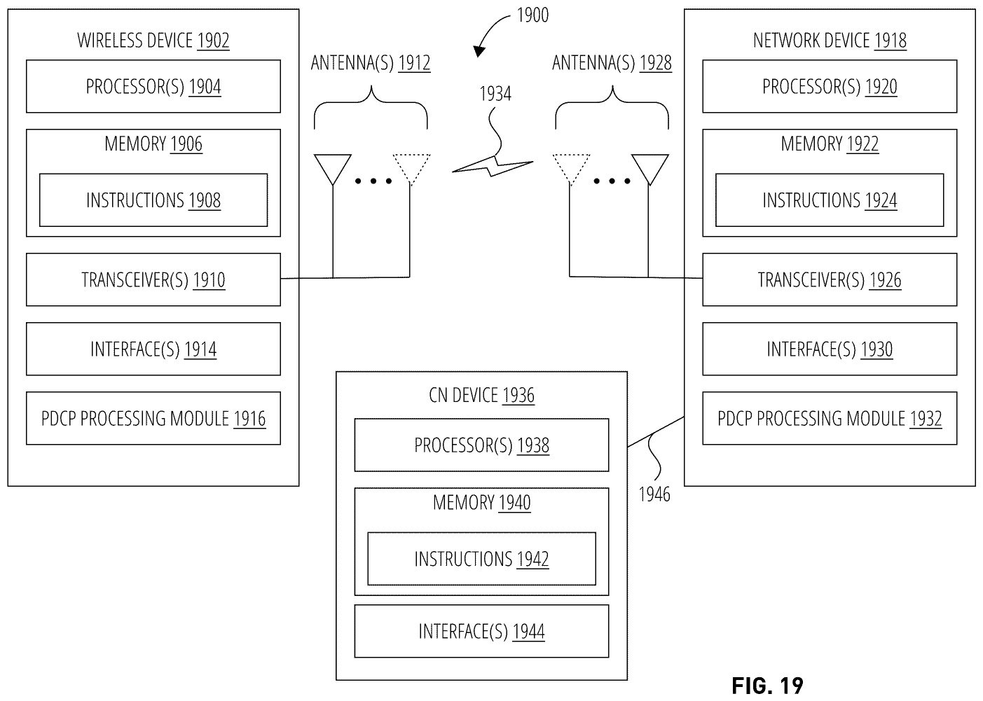

FIG. 19 illustrates a system 1900 for performing signaling 1934 between a wireless device 1902 and a network device 1918 as supported by a CN device 1936, according to embodiments disclosed herein. The system 1900 may be a portion of a wireless communications system as herein described. The wireless device 1902 may be, for example, a UE of a wireless communication system. The network device 1918 may be, for example, a base station (e.g., an eNB, a gNB, or a sixth generation base station) of a wireless communication system.

The wireless device 1902 may include one or more processor(s) 1904. The processor(s) 1904 may execute instructions such that various operations of the wireless device 1902 are performed, as described herein. The processor(s) 1904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1902 may include a memory 1906. The memory 1906 may be a non-transitory computer-readable storage medium that stores instructions 1908 (which may include, for example, the instructions being executed by the processor(s) 1904). The instructions 1908 may also be referred to as program code or a computer program. The memory 1906 may also store data used by, and results computed by, the processor(s) 1904.

The wireless device 1902 may include one or more transceiver(s) 1910 that may include radio frequency (RF) transmitter circuitry and/or receiver circuitry that use the antenna(s) 1912 of the wireless device 1902 to facilitate signaling (e.g., the signaling 1934) to and/or from the wireless device 1902 with other devices (e.g., the network device 1918) according to corresponding RATs.

The wireless device 1902 may include one or more antenna(s) 1912 (e.g., one, two, four, or more). For embodiments with multiple antenna(s) 1912, the wireless device 1902 may leverage the spatial diversity of such multiple antenna(s) 1912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1902 may be accomplished according to precoding (or digital beamforming) that is applied at the wireless device 1902 that multiplexes the data streams across the antenna(s) 1912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1902 may implement analog beamforming techniques, whereby phases of the signals sent by the antenna(s) 1912 are relatively adjusted such that the (joint) transmission of the antenna(s) 1912 can be directed (this is sometimes referred to as beam steering).

The wireless device 1902 may include one or more interface(s) 1914. The interface(s) 1914 may be used to provide input to or output from the wireless device 1902. For example, a wireless device 1902 that is a UE may include interface(s) 1914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1910/antenna(s) 1912 already described) that allow for communication between the UE and other devices and may operate according to known protocols (e.g., Wi-Fi®, Bluetooth®, and the like).

The wireless device 1902 may include a PDCP processing module 1916. The PDCP processing module 1916 may be implemented via hardware, software, or combinations thereof. For example, the PDCP processing module 1916 may be implemented as a processor, circuit, and/or instructions 1908 stored in the memory 1906 and executed by the processor(s) 1904. In some examples, the PDCP processing module 1916 may be integrated within the processor(s) 1904 and/or the transceiver(s) 1910. For example, the PDCP processing module 1916 may be implemented by a combination of software components (e.g., executed by a DSP or a general processor) and hardware components (e.g., logic gates and circuitry) within the processor(s) 1904 or the transceiver(s) 1910.

The PDCP processing module 1916 may be used for various aspects of the present disclosure, for example, aspects of FIG. 14 and/or FIG. 15. The PDCP processing module 1916 may configure a wireless device 1902 that is a UE to perform PDCP processing for a PDCP layer as a transmitter and/or as a receiver, as discussed herein.

The network device 1918 may include one or more processor(s) 1920. The processor(s) 1920 may execute instructions such that various operations of the network device 1918 are performed, as described herein. The processor(s) 1920 may include one or more baseband processors implemented using, for example, a CPU, a DSP, an ASIC, a controller, an FPGA device, another hardware device, a firmware device, or any combination thereof configured to perform the operations described herein.

The network device 1918 may include a memory 1922. The memory 1922 may be a non-transitory computer-readable storage medium that stores instructions 1924 (which may include, for example, the instructions being executed by the processor(s) 1920). The instructions 1924 may also be referred to as program code or a computer program. The memory 1922 may also store data used by, and results computed by, the processor(s) 1920.

The network device 1918 may include one or more transceiver(s) 1926 that may include RF transmitter circuitry and/or receiver circuitry that use the antenna(s) 1928 of the network device 1918 to facilitate signaling (e.g., the signaling 1934) to and/or from the network device 1918 with other devices (e.g., the wireless device 1902) according to corresponding RATs.

The network device 1918 may include one or more antenna(s) 1928 (e.g., one, two, four, or more). In embodiments having multiple antenna(s) 1928, the network device 1918 may perform MIMO, digital beamforming, analog beamforming, beam steering, etc., as has been described.

The network device 1918 may include one or more interface(s) 1930. The interface(s) 1930 may be used to provide input to or output from the network device 1918. For example, a network device 1918 that is a base station may include interface(s) 1930 made up of transmitters, receivers, and other circuitry (e.g., other than the transceiver(s) 1926/antenna(s) 1928 already described) that enables the base station to communicate with other equipment in a core network, and/or that enables the base station to communicate with external networks, computers, databases, and the like for purposes of operations, administration, and maintenance of the base station or other equipment operably connected thereto. As another example, the network device 1918 may communicate with the CN device 1936 on an interface 1946 of the interface(s) 1930 (which, in, for example, NR cases, may be an NG interface or in LTE cases may be an S1 interface).

The network device 1918 may include a PDCP processing module 1932. The PDCP processing module 1932 may be implemented via hardware, software, or combinations thereof. For example, the PDCP processing module 1932 may be implemented as a processor, circuit, and/or instructions 1924 stored in the memory 1922 and executed by the processor(s) 1920. In some examples, the PDCP processing module 1932 may be integrated within the processor(s) 1920 and/or the transceiver(s) 1926. For example, the PDCP processing module 1932 may be implemented by a combination of software components (e.g., executed by a DSP or a general processor) and hardware components (e.g., logic gates and circuitry) within the processor(s) 1920 or the transceiver(s) 1926.

The PDCP processing module 1932 may be used for various aspects of the present disclosure, for example, aspects of FIG. 16 and/or FIG. 17. The PDCP processing module 1932 may configure a network device 1918 that is a base station to perform PDCP processing for a PDCP layer as part of a cluster of base stations that is a transmitter and/or as a receiver, as discussed herein.

The CN device 1936 may include one or more processor(s) 1938. The processor(s) 1938 may execute instructions such that various operations of the CN device 1936 are performed, as described herein. The processor(s) 1938 may include one or more baseband processors implemented using, for example, a CPU, a DSP, an ASIC, a controller, an FPGA device, another hardware device, a firmware device, or any combination thereof configured to perform the operations described herein.

The CN device 1936 may include a memory 1940. The memory 1940 may be a non-transitory computer-readable storage medium that stores instructions 1942 (which may include, for example, the instructions being executed by the processor(s) 1938). The instructions 1942 may also be referred to as program code or a computer program. The memory 1940 may also store data used by, and results computed by, the processor(s) 1938.

The CN device 1936 may include one or more interface(s) 1944. The interface(s) 1944 may be used to provide input to or output from the CN device 1936. For example, a CN device 1936 may communicate with the network device 1918 on an interface 1946 of the interface(s) 1944 (which, in, for example, NR cases, may be an NG interface or in LTE cases may be an S1 interface).

Embodiments contemplated herein include an apparatus comprising means to perform one or more elements of any of the method 1400 and/or the method 1500. This apparatus may be, for example, an apparatus of a UE (such as a wireless device 1902 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 1400 and/or the method 1500. This non-transitory computer-readable media may be, for example, a memory of a UE (such as a memory 1906 of a wireless device 1902 that is a UE, as described herein).

Embodiments contemplated herein include an apparatus comprising logic, modules, or circuitry to perform one or more elements of any of the method 1400 and/or the method 1500. This apparatus may be, for example, an apparatus of a UE (such as a wireless device 1902 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 1400 and/or the method 1500. This apparatus may be, for example, an apparatus of a UE (such as a wireless device 1902 that is a UE, as described herein).

Embodiments contemplated herein include a signal as described in or related to one or more elements of any of the method 1400 and/or the method 1500.

Embodiments contemplated herein include a computer program or computer program product comprising instructions, wherein execution of the program by a processor is to cause the processor to carry out one or more elements of any of the method 1400 and/or the method 1500. The processor may be a processor of a UE (such as a processor(s) 1904 of a wireless device 1902 that is a UE, as described herein). These instructions may be, for example, located in the processor and/or on a memory of the UE (such as a memory 1906 of a wireless device 1902 that is a UE, as described herein).

Embodiments contemplated herein include an apparatus comprising means to perform one or more elements of any of the method 1600 and/or the method 1700. This apparatus may be, for example, an apparatus of a base station (such as a network device 1918 that is a base station, as described herein). It is further contemplated that this apparatus may be one of many such apparatuses working together in a distributed fashion to perform the one or more elements of any of the method 1600 and/or the method 1700.

Embodiments contemplated herein include one or more non-transitory computer-readable media comprising instructions to cause an electronic device, upon execution of the instructions by one or more processors of the electronic device, to perform one or more elements of any of the method 1600 and/or the method 1700. This non-transitory computer-readable media may be, for example, a memory of a base station (such as a memory 1922 of a network device 1918 that is a base station, as described herein). It is further contemplated that the electronic device may be one of many such electronic devices working together in a distributed fashion to perform the one or more elements of any of the method 1600 and/or the method 1700.

Embodiments contemplated herein include an apparatus comprising logic, modules, or circuitry to perform one or more elements of any of the method 1600 and/or the method 1700. This apparatus may be, for example, an apparatus of a base station (such as a network device 1918 that is a base station, as described herein). It is further contemplated that this apparatus may be one of many such apparatuses working together in a distributed fashion to perform the one or more elements of any of the method 1600 and/or the method 1700.

Embodiments contemplated herein include an apparatus comprising: one or more processors and one or more computer-readable media comprising instructions that, when executed by the one or more processors, cause the one or more processors to perform one or more elements of any of the method 1600 and/or the method 1700. This apparatus may be, for example, an apparatus of a base station (such as a network device 1918 that is a base station, as described herein). It is further contemplated that this apparatus may be one of many such apparatuses working together in a distributed fashion to perform the one or more elements of any of the method 1600 and/or the method 1700.

Embodiments contemplated herein include a signal as described in or related to one or more elements of any of the method 1600 and/or the method 1700.

Embodiments contemplated herein include a computer program or computer program product comprising instructions, wherein execution of the program by a processing element is to cause the processing element to carry out one or more elements of any of the method 1600 and/or the method 1700. The processor may be a processor of a base station (such as a processor(s) 1920 of a network device 1918 that is a base station, as described herein). These instructions may be, for example, located in the processor and/or on a memory of the base station (such as a memory 1922 of a network device 1918 that is a base station, as described herein). It is further contemplated that the processing element may be one of many such processing elements working together in a distributed fashion to perform the one or more elements of any of the method 1600 and/or the method 1700.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) that is served by a cluster of base stations for packet data convergence protocol (PDCP) processing for a PDCP entity, comprising:
generating a concatenated service data unit (SDU) set by concatenating a plurality of SDUs for a protocol data unit (PDU) set;
segmenting the concatenated SDU set into one or more systematic PDUs of the PDU set;
performing an encoding with the one or more systematic PDUs to generate one or more redundant PDUs of the PDU set; and
distributing the one or more systematic PDUs and the one or more redundant PDUs across one or more radio link control (RLC) entities for transmission to one or more sub-clusters of the cluster of base stations that correspond to the one or more RLC entities.

2. The method of claim 1, wherein the concatenated SDU set is further generated by:
generating an authentication code for the plurality of SDUs; and
concatenating, within the concatenated SDU set, the authentication code with the plurality of SDUs.

3. The method of claim 1, further comprising ciphering the concatenated SDU set prior to segmenting the concatenated SDU set.

4. The method of claim 1, wherein the encoding comprises a Reed-Solomon erasure encoding.

5. The method of claim 1, further comprising selecting an RLC ratio, wherein the one or more systematic PDUs and the one or more redundant PDUs are distributed across the RLC entities according to the RLC ratio.

6. The method of claim 5, further comprising receiving, from the cluster, a recommended RLC ratio, wherein the RLC ratio is selected by the UE according to the recommended RLC ratio.

7. The method of claim 1, wherein the PDU set comprises a virtual PDU set.

8. A method of a user equipment (UE) that is served by a cluster of base stations for packet data convergence protocol (PDCP) processing for a PDCP entity, comprising:
receiving, from one or more radio link control (RLC) entities corresponding to one or more sub-clusters of the cluster of base stations, one or more protocol data units (PDUs) of a PDU set;
performing, based on a determination that a number of the one or more PDUs is greater than or equal to a number of systematic PDUs for the PDU set, a decoding with the one or more PDUs of the PDU set to generate a concatenated service data unit (SDU) set;
decomposing the concatenated SDU set into a plurality of SDUs for the PDU set; and
providing the plurality of SDUs to a higher layer protocol entity of the UE.

9. The method of claim 8, further comprising:
retrieving an authentication code for the plurality of SDUs from the concatenated SDU set; and
authenticating the plurality of SDUs using the authentication code.

10. The method of claim 8, further comprising deciphering the concatenated SDU set prior to decomposing the concatenated SDU set.

11. The method of claim 8, wherein the decoding comprises a Reed-Solomon erasure decoding.

12. The method of claim 8, wherein the PDU set comprises a virtual PDU set.

13. A method of a cluster of base stations that is serving a user equipment (UE) for packet data convergence protocol (PDCP) processing for a PDCP entity, comprising:
generating a concatenated service data unit (SDU) set by concatenating a plurality of SDUs for a protocol data unit (PDU) set;
segmenting the concatenated SDU set into one or more systematic PDUs of the PDU set;
performing an encoding with the one or more systematic PDUs to generate one or more redundant PDUs of the PDU set; and
distributing the one or more systematic PDUs and the one or more redundant PDUs across one or more radio link control (RLC) entities corresponding to one or more sub-clusters of the cluster of base stations for transmission to the UE.

14. The method of claim 13, wherein the concatenated SDU set is further generated by:
generating an authentication code for the plurality of SDUs; and
concatenating, within the concatenated SDU set, the authentication code with the plurality of SDUs.

15. The method of claim 13, further comprising ciphering the concatenated SDU set prior to segmenting the concatenated SDU set.

16. The method of claim 13, wherein the encoding comprises a Reed-Solomon erasure encoding.

17. The method of claim 13, further comprising selecting an RLC ratio, wherein the one or more systematic PDUs and the one or more redundant PDUs are distributed across the RLC entities according to the RLC ratio.

18. The method of claim 17, further comprising receiving, from the UE, a recommended RLC ratio, wherein the RLC ratio is selected by the PDCP entity according to the recommended RLC ratio.

19. The method of claim 13, further comprising receiving, from a clustering control function (CCF) for the cluster of base stations, an RLC ratio, wherein the one or more systematic PDUs and the one or more redundant PDUs are distributed across the RLC entities according to the RLC ratio.

20. The method of claim 13, wherein the PDU set comprises a virtual PDU set.
